(19) United States
(12) Patent Application Publication
(10) Pub. No.: US 2006/0277128 A1
(43) Pub. Date: Dec. 7, 2006

(54) System and method for managing and monitoring financial performance associated with benefits

(76) Inventors: Sudhir Anandarao, Vienna, VA (US); James W. Benefiel, Ashburn, VA (US); Fletcher D. Gill, Rockville, MD (US); Sreedhar V. Potarazu, Potomac, MD (US); James T. Tierney, Potomac Falls, VA (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/146,283

(22) Filed: Jun. 7, 2005

(51) Int. Cl. G06Q 40/00

(52) U.S. Cl. 705/35; 705/38

(57) ABSTRACT

Data associated with a benefit plan, including enrollment data and claims data, are compared to verify proper payment of claims. Additionally, other information, such as general ledger, employer account information, and employer organizations can be considered. Information can be output to a user, such as a plan administrator, in a form convenient for that user to quickly understand a large amount of information and how that information relates to a business or other entity administering the benefit plan. Various techniques can be used to estimate reserves, and can optionally use a claims lag triangle as input, including a claims lag report method, a earned premium method, and iterative method, and a regression method, for example.

### FIELD OF THE INVENTION

The invention generally relates to healthcare-related benefits and other benefits. More specifically, the invention relates to managing and monitoring financial performance associated with benefits and benefit plans.

### BACKGROUND

Various employee fringe benefits can be, and traditionally have been, provided to individuals by way of benefit plans. For example, benefits such as medical coverage, prescription drugs, and retirement accounts are frequently provided to individuals, as beneficiaries by way of benefit plans offered by a provider, through an employer, for example. Benefit plans also can be administered by a third party, which may be neither a provider nor a beneficiary to the benefit plan.

Administration of benefit plans can be complex. For example, the benefit plans themselves can be rather complex and take into consideration numerous factors, some of which may not be readily appreciated from a casual review or understanding of the benefit plan. Additionally, implementation of even a simple benefit plan can be complex, and require consideration of numerous factors. Nevertheless, benefit plans can be important to both plan sponsors and to many individuals who are beneficiaries under or otherwise participate in the plans.

In recent years, costs associated with some benefit plans have increased dramatically, causing concern to both plan sponsors and plan beneficiaries or members. For example, a major component of some benefit plans is medical costs or other healthcare-related costs. As medical and other healthcare-related costs have increased rapidly in recent years, so too have costs associated with the various plans. These increased costs are often, in turn, passed through to the plan sponsor and/or the plan membership. In addition to concern over rising medical or healthcare-related costs, concerns also sometimes exist for the efficiency of a benefit plan, or other factors that can cause benefit-plan-related expenses to rise, such as payment of repeat claims, payment of claims for individuals not enrolled in the plan, and so forth.

Based on concern for efficiency and/or rising costs associated with various benefit plans, administration tools and techniques for managing benefit plans have increased in importance and demand in recent years. Current benefit plan analysis and management tools and techniques, however, are rather limited in the functionality that they provide. For example, there exists a need to allow a benefit plan sponsor and/or administrator the capability of readily viewing and assessing the financial performance of benefit plans, for example, as that performance relates to accounts or organizations of the plan sponsor. Additionally, there is a need to be able to relate financial information associated with benefit plans to actual financial data of an entity providing or administering such a plan.

Accordingly, it would be desirable to develop a system and method for managing and monitoring financial performance of benefits that overcome the problems and shortcomings associated with prior approaches.

### SUMMARY

According to at least one embodiment of the invention, a technique is provided for comparing electronic data associated with claims under a benefit plan and data associated with an entity administering that benefit plan (e.g., a sponsor or administrator such as an employer). For example, electronic data representing claims under the benefit plan can be compared with data representing enrollment information associated with the benefit plan and/or general ledger (GL) accounting information associated with the benefit plan. Once the information is compared, a convenient display referred to as a dashboard can be used to display information about the data analyzed. For example, one or more dashboards can be used to display benefits information, such as health benefits information, in a format readily understandable and usable by individuals associated with an entity administering the benefit plan to monitor and manage financial performance of the benefit plan, if desired. For example, a health benefits dashboard can display information sorted by account, providing a monthly breakdown of headcount and actual/forecast benefit dollars for a selected account. Additionally, a dashboard can be used to show similar health benefits information sorted by account and organization level within the organization administering the benefit plan. Similarly, information, such as an employer costs for the benefits can be displayed in a dashboard, and broken down by business units and various levels of organization.

Various financial management tools provided according to one or more embodiments of the invention can be used to estimate reserves based on claims incurred under a benefit plan. For example, a construct called a “claims lag triangle” can be used to calculate lag time between a claim being incurred and the claim being paid. A claims lag triangle can then be used in one of a number of techniques, such as a claims lag report method, an earned premium method, and an iterative method for estimating reserves.

Other advantages and features associated with embodiments of the invention will become more readily apparent to those skilled in the art from the following detailed description. As will be realized, the invention is capable of other and different embodiments than those described explicitly herein, and its several details are capable of modification in various aspects, all without departing from the invention. Accordingly, the drawings and the description are to be regarded as illustrative in nature, and not limiting.

### BRIEF DESCRIPTION OF THE DRAWINGS

FIG. 1 is a block diagram of a system used to manage and monitor financial performance associated with benefits, according to an embodiment of the invention.

FIG. 2 is a block diagram illustrating delays associated with payment of claims, according to an embodiment of the invention.

FIG. 3 is a block diagram illustrating various functions and data used by those functions, according to an embodiment of the invention.

FIG. 4 is a flow diagram illustrating steps for comparing claims data, enrollment data and general ledger data, according to an embodiment of the invention.

FIG. 5 is a flow diagram illustrating steps for organizing and displaying claims data and administrator data, according to an embodiment of the invention.

FIG. 6 is a bar chart illustrating actual costs and forecast costs for a particular account, according to an embodiment of the invention.

FIG. 7 is a graph illustrating actual costs and forecast costs for a particular account, according to an embodiment of the invention.

FIG. 8 is a pie chart illustrating actual costs and forecast costs for a particular account, according to an embodiment of the invention.

FIG. 9 is a flow diagram illustrating steps for estimating reserves, according to an embodiment of the invention.

FIG. 10 is a flow diagram illustrating steps for forecasting future data, according to an embodiment of the invention.

### DETAILED DESCRIPTION

One or more systems and methods for managing and monitoring financial performance associated with benefits are described. More specifically, one or more embodiments of the invention is described in the context of using one or more dashboards that can be presented to individuals associated with an entity administering a benefit plan, and one or more techniques for estimating reserves associated with the benefit plan. Additionally, one or more embodiments of the invention provide techniques for analyzing financial performance of a benefit plan.

For example, according to one or more embodiments of the invention, various types of claims data can be analyzed, and can be compared with internal data from an entity administering a benefit plan (e.g., provider, an administrator, an employer, etc.), such as enrollment data, financial general ledger (GL) data, or the like. The results of the various analyses of data can be presented to an individual using one or more dashboards, such as a health benefits dashboard organized by account, a health benefits dashboard organized by account and organization level, and an employer cost dashboard organized by account and organization level. The health benefits by account dashboard can present a monthly breakdown of headcount and actual or forecast dollars by account. Similarly, the health benefits by account and organization level dashboard can present similar monthly information organized by account and organization level. The employer cost by account and organization level dashboard can be used to display costs by account and according to various business units and organization levels within the entity administering the benefit plan.

In addition to the dashboards and other techniques used to present data and analysis of that data associated with claims and internal information of the entity administering a benefit plan, various financial management tools and techniques can be used to estimate reserves, allowing for proactive budgeting and management of benefits dollars and accounts associated with those dollars. For example, the amount of reserves under a benefit plan can be calculated and forecast for one or more accounts within an entity associated with the benefit plan using a variety of techniques. Several such techniques involve using a claims lag triangle, which represents, in tabular format, the delay or “lag” time between a claim being incurred under a benefit plan, and that claim being paid under the benefit plan.

According to a further optional aspect of the invention the claims lag triangle, including, for example, a claims lag report method, an earned premium method, and an iterative method. The claims lag report method uses “completion factors” for estimating claims incurred but not paid. The earned premium method determines an average claim rate, and multiplies that average claim rate by a monthly earned premium to estimate the amount of reserves. The iterative method, which can be particularly effective for estimating reserves over a smaller number of months, uses previous values within the claim lag triangle to calculate forecast values within that triangle. Examples of each of these estimation techniques are described in greater detail below.

As used herein, the term “benefit plan” means a system by which benefits are provided to one or more individuals that are members of the plan. For example, a benefit plan can include a medical plan, a pharmacy plan, a retirement plan, an insurance plan, a pension plan, a workers compensation plan, a disability plan (e.g., short-term or long-term), a dental-care plan (also referred to as a dental plan), a vision-related plan (also referred to as a vision plan), a medical leave plan, a maternity/paternity plan, and/or other similar plans or plans that provide similar types of benefits. Additionally, a benefit plan can include a combination of two or more of the foregoing examples of benefit plans. A benefit plan can be administered, sponsored, or provided by an employer, an insurance company, a non-profit organization, or other entities having an interest in providing the associated benefits of the benefit plan. Administration, sponsorship and/or provision of a benefit plan can occur by the same entity or different entities, as desired. An entity responsible for administering a benefit plan can be referred to generically as an “administering entity” or an “administrating entity.”

As used herein, the term “member” means any individual eligible to receive benefits from a benefit plan. Generally, to be eligible to receive benefits from a benefit plan, a member must be enrolled within (or “under”) that benefit plan, according to the rules of the benefit plan. Members can also be referred to as “beneficiaries,” inasmuch as they receive benefits from the benefit plan. The term “beneficiary” is somewhat more expansive than “member” as employees are generally eligible to receive workmen's compensation benefits (e.g., after a specified employment period) even though there is no enrollment process, and no benefit plan to select. Members can also be referred to using designations associated with their specific benefit plan; for example, the term “retiree” can be used to describe a member of a retirement plan. A “member population” or “membership” is a group of members eligible to receive benefits from a common benefit plan.

As used herein, the term “claim” refers to a request, or demand, for a benefit, or a payment to a benefit plan provider pursuant to a benefit plan (e.g., a healthcare provider, an insurer, etc.). For example, a claim under a medical benefit plan might be made to the plan sponsor by a physician or other healthcare provider. A claim under such a medical benefit plan might also be made by an insurer that paid for service received by a plan member. Under a disability benefit plan, a claim would likely be made by an insurer on behalf of a plan member, or directly by the member. A claim generally is made when a benefit provider believes it is entitled to payment for services rendered to a plan member under the benefit plan.

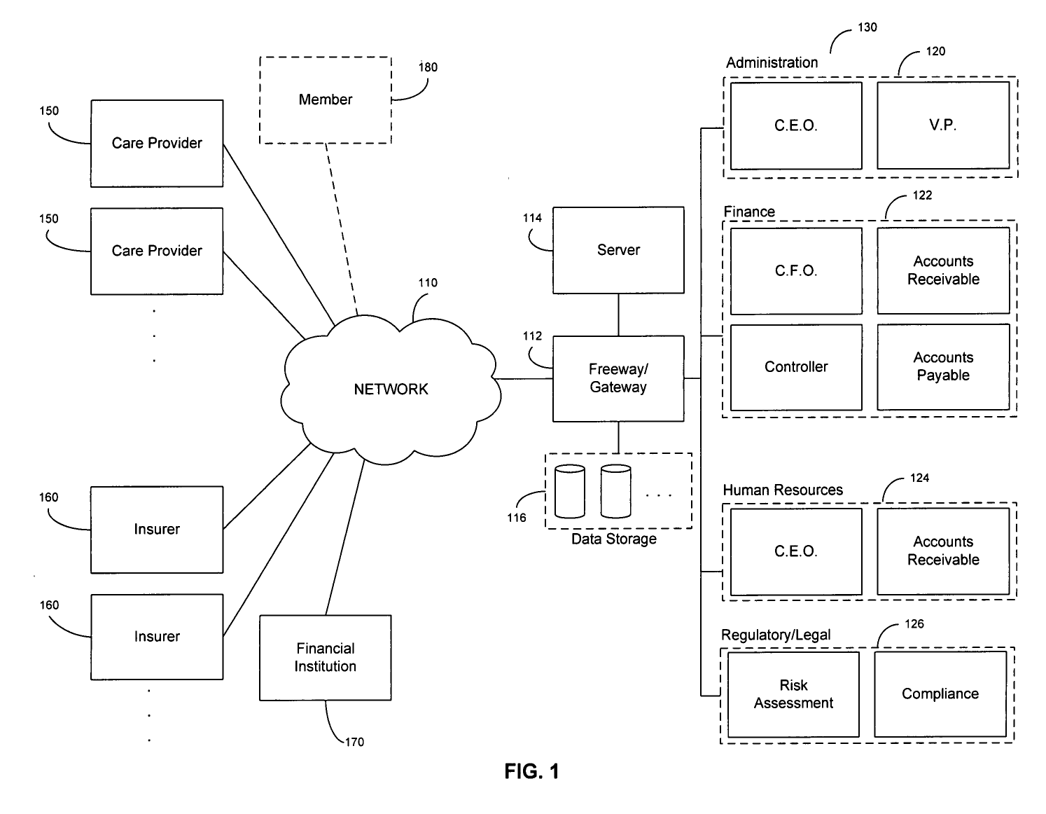

FIG. 1 is a block diagram of a system 100 used to manage and monitor financial performance associated with benefits, according to an embodiment of the invention. The system 100 shown in FIG. 1 includes a variety of devices connected to or in communication with a communications network 110. By way of the network 110, a variety of devices can communicate using one or more suitable communications protocols, such as transport control protocol (TCP), internet protocol (IP), or other suitable protocols.

On the right-hand side of the system 100 shown in FIG. 1, various devices are connected to the network 110 from within an entity administering a benefit plan (e.g., an employer, etc.) by way of a firewall/gateway 112. The firewall/gateway 112 can monitor communications to and from the open network 110, and can prevent malicious data packets from interfering with the various systems within an administrating entity's local network 130. Similarly, the firewall/gateway 112 can prevent unauthorized transmission of sensitive information from within the administrating entity's internal, local network 130.

A server 114, and one or more data storage devices 116 can be connected to devices within the administrating entity's internal network 130 either directly or by way of the firewall/gateway 112, as illustrated in FIG. 1. The server 114 can be used to route communications between the various devices within the administration entity's local network 130 (e.g., a local area network or LAN, etc.). The data storage component 116 can be a single device, or it can include multiple devices capable of storing electronic data for use by the various devices connected to the network 110or to the firewall/gateway 112. Access to the various data stored within the data storage devices 116 can be monitored by and limited by the firewall/gateway 112.

The administrating entity's internal network 130 can include devices associated with a number of business units or organization levels. For example, devices associated with various individuals within administration 120, devices associated with individuals within finance 122, devices associated with individuals in human resources 124 and/or devices associated with individuals within regulatory or legal 126 can communicate with one another by way of an internal network 130, such as a local area network (LAN), a wide area network (WAN), or the like. The various devices connected to the network 110 by way of the internal network 130 can access the data stored within the data storage devices 116, and can receive and send communications to other devices connected to the internal network 130 or the network 110 (e.g., by way of the firewall/gateway 112), as may be directed by the server 114, for example.

It should be understood that although labels corresponding to various business units or organization levels within an entity administering a benefit plan are shown in FIG. 1, these labels represent devices from these various business units or organization levels that communicate via the internal network 130. Similarly, labels corresponding to various offices or individuals within these organization levels are also used in FIG. 1 to represent devices accessed by these offices or individuals. For example, within the administration 120, one or more executives such as a chief executive officer (CEO), or a vice president (VP) may wish to view data received via the network 110, or the results of analyses upon that data using devices within the local network 130. Similarly, within finance 122, various individuals or offices may wish to access similar data or analyses of that data using devices within the local network 130, including individuals such as the chief financial officer (CFO), the controller, accounts receivable staff, and accounts payable staff. Within human resources 124, the vice president (VP) of human resources as well as a designated plan administrator may wish to access data or the analyses of data via the local network 130 using devices within the local network 130. In addition, individuals within the regulatory or legal organization 126, such as individuals involved with risk assessment or compliance, may wish to have access to similar data and analyses using devices within the local network 130. Additional organization levels may be part of the administering entity and may participate in the arrangement of the invention. Also, additional or alternative individuals within any of these groups may participate in the arrangement.

In addition to devices within the administrating entity, devices associated with other entities, or in other words outside of the local network 130, can also communicate with the administrating entity and its associated devices by way of the network 110. For example, one or more care providers 150 can provide information associated with care provided under a benefit plan and/or related to claims associated with such a benefit plan (e.g., claims data). These care providers 150 can include, for example, physicians, dentists, and other benefit providers that provide care to one or more members under a benefit plan. Similarly, one or more insurers 160 can communicate via the network 110. These insurers 160 can provide, for example, data such as claims data, or other data of interest to an entity administering a benefit plan.

Many other institutions can communicate with an administrating entity via the network 110. For example, a financial institution 170 is shown in FIG. 1 communicating via the network 110. This financial institution can provide information, such as the date payments are made under a benefit plan, or other information of interest to an administrating entity or others associated with a benefit plan. Additionally, a member 180 can optionally communicate via the network 110 and can, for example, provide information useful to an administrating entity, such as benefit information, claims payment information, or the like. Although it is not necessary for a member 180 to communicate via the network 110 to provide information useful for an administrating entity, in some cases it may be desirable or useful to such an administrating entity, as a convenient way of obtaining information that might require more effort to obtain through other sources.

It should be understood that, in addition to the various components, devices, and entities shown in FIG. 1, other devices not shown, or duplicates of devices shown can be used, if desired. Similarly, it should be understood that, although certain labels are given in FIG. 1 that appear to indicate specific organizations, offices, people, or positions, the use of those labels in FIG. 1 is intended to indicate devices associated with such organizations, offices, people, or positions.

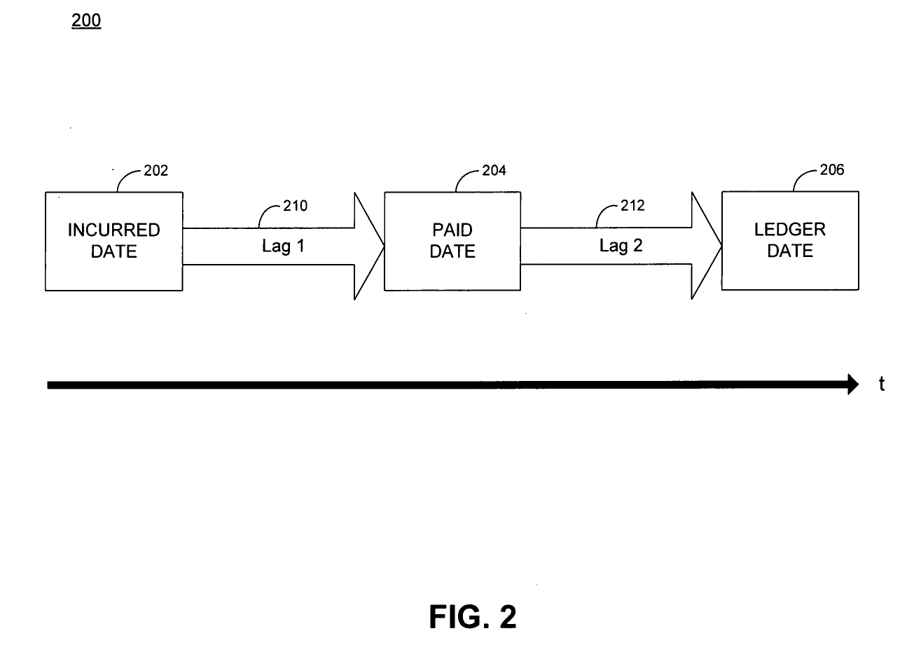

FIG. 2 is a block diagram illustrating delays associated with payment of claims, according to an embodiment of the invention. In FIG. 2, an incurred date 202 is illustrated at the left-hand side of the figure (i.e., at the earliest time represented in the figure), which corresponds to a date on which a patient or a member under a benefit plan receives service and, thus, incurs a claim. The incurred date 202 is also sometimes referred to as a service date. A paid date 204 is also illustrated, and corresponds to the date on which an insurance plan, or other benefit plan, cut a check or otherwise approved another form of payment to the benefit provider and marked the claim as “paid.” This date is also sometimes referred to herein as a calendar date, indicating the calendar date on which the payment is approved. Both the incurred date 202 and the paid date 204 can be received, according to one or more embodiments of the invention, as part of claims data, which may be received electronically by an entity that administers a benefit plan.

The first time delay or time “lag” is illustrated as “Lag 1” 210. The lag between the incurred date and the paid date can vary in length, but often is between a few weeks and many months, depending upon the speed with which claims are made and processed. Because of this first time lag 210, it is sometimes difficult for organizations to track claims made under a benefit plan. As will be described in greater detail below, various financial management techniques can be employed to account for this first time lag 210 between the date a claim is incurred 202 and the date on which it is paid 204, such that an entity administering a benefit plan can more precisely track claims, according to one or more embodiments of the invention. For example, various techniques using a “claims lag triangle,” or other techniques for estimating reserves described below, are intended to address inconsistencies in information available to the administrating entity that might otherwise be introduced by way of this first time lag 210.

In FIG. 2, a ledger date 206 is also shown, and corresponds to a date on which a transaction from a benefit plan administrator to an insurer occurs. For example, in a case where an employer administers a benefit plan, the ledger date 206 is the date on which the transaction actually occurs between the employer and an insurance vendor, or in other words, the date on which the employer incurs the financial liability of a claim for financial accounting purposes. This ledger date 206 forms the basis of general ledger (GL) data, which may be used by one or more accounts or organizations within an administrating entity.

A second time lag “Lag 2” 212 is illustrated as occurring between the paid date 204 and the ledger date 206. In other words, after a check is cut by an insurance vendor or other administrating entity on the paid date 206, there is a second time delay until the payment is processed and the employer or other administrating entity becomes liable for that financial obligation. The second time lag 212 can be viewed, according to one or more embodiments of the invention, as an administrative lag associated with paying providers (or insurance vendors). This second lag 212 can become important in corporate financial scorecards, as it represents a difference between the paid date 204 (which is the time basis of claims data feeds) and the ledger date 206 (which is the time basis of general ledger data feeds). Typically, the second lag 212 can range from a few days to a few weeks, depending upon the speed with which payments are processed. Because of the second lag 212, if full reconciliation between claims data and internal accounting data (e.g., general ledger data) is desired, such as for compliance or risk assessment purposes, then the ledger date 206 can be used, along with data associated therewith, to fully reconcile any general ledger entries.

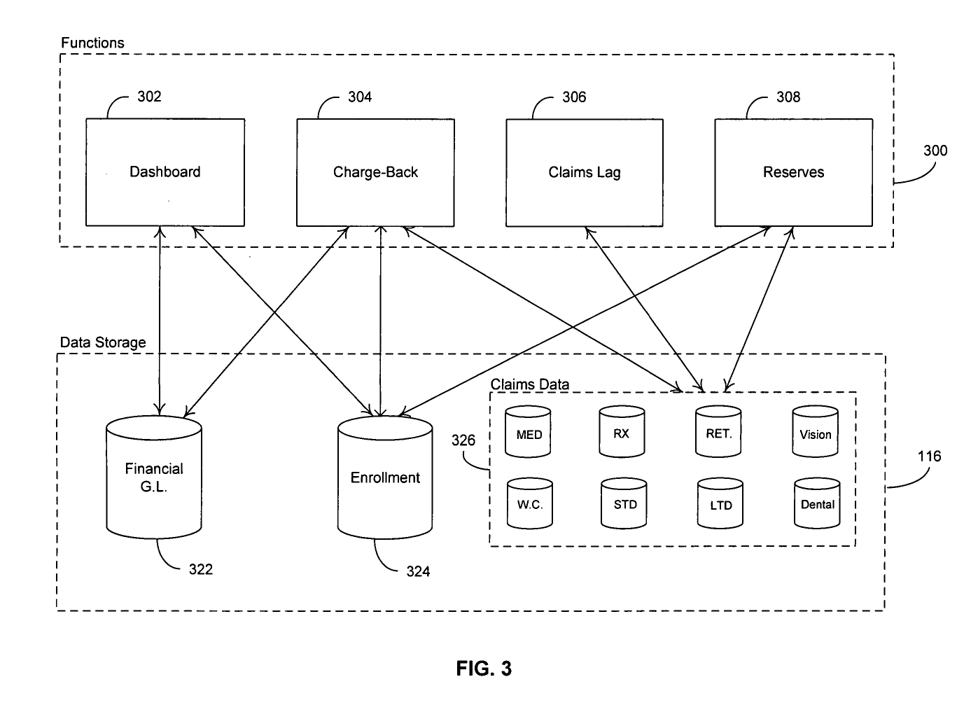

FIG. 3 is a block diagram illustrating various functions 300 and data 116 used by those functions, according to an embodiment of the invention. In FIG. 3, various functions 300 are illustrated, including the capability to provide information in dashboard format 302, charge-back analysis capability 304, claims lag analysis capability 306, and reserves estimation techniques 308. Each of the functions 300 shown in FIG. 3 can be implemented within the local network 130 shown in FIG. 1 by various devices connected thereto. These functions 300 are discussed in greater detail below.

FIG. 3 also illustrates the relationship between specific types of data and the various functions 300 that can be executed by an entity administering a benefit plan, or a designee of such an entity within the local network 130. Although the data storage devices 116 are illustrated as communicating with the firewall/gateway 112 in FIG. 1, some of this data can be provided from sources external to the local network 130, and can be received over an open network 110, or by another suitable technique. The data storage devices 116 include a financial general ledger (GL), storage device 322, and enrollment storage device 324, and a series of claims data storage devices 326. As illustrated in FIG. 3, the claims data storage devices 326 can include medical, prescription drug, retirement, vision, dental, long term disability (LTD), short term disability (STD), and workers compensation data storage devices, or other devices storing data of interest for the various functions 300 shown in FIG. 3. It should be recognized that, although various data storage devices 116 are illustrated in FIG. 3, these devices need not be exclusively hardware components configured to store data. Instead, the data storage devices 116 represent any device or technique whereby the various types of data described in connection with those storage devices 116 can be stored and/or transmitted to the functions 300 shown in FIG. 3 for use. Thus, each of the devices 116 can also be a data feed, such as a real-time feed, or the like.

As can be seen in FIG. 3, the dashboard function 302 combines financial GL data 322 and enrollment data 324. Thus, an entity administrating a benefit plan can match financial GL data 322 to enrollment data 324, and display results using the dashboard function 302. The charge-back function 304 can be used to report financial GL data 322, enrollment data 324, and any type of claims data 326, down to business units in various levels of the organization. For example, the charge-back function 304 can be used to compare claims data 326 to enrollment data 324 to determine if claims received by an administrating entity are for validly enrolled members under a benefit plan. The claims lag function 306 uses claims data 326 to determine the first lag 210 shown in FIG. 2, by way of one or more techniques, such as using a claims lag triangle, as described in greater detail below. The reserves function 308 can use both enrollment data 324 and claims data 326 to estimate reserves under the benefit plan. In calculating estimated reserves, the reserves function 308 can also use data obtained from the claims lag function, if desired. Similarly, results from any one of the functions 300 shown in FIG. 3 can be communicated to other functions 300 for further use and analysis, if desired.

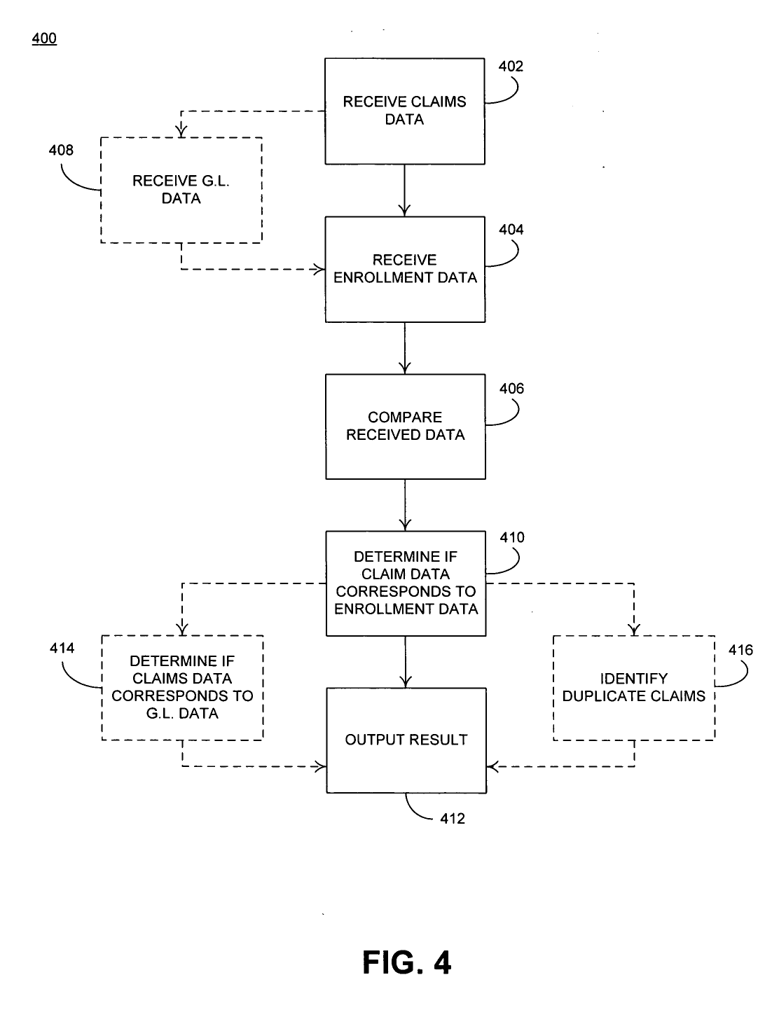

FIG. 4 is a flow diagram illustrating steps for comparing claims data and enrollment data, according to an embodiment of the invention. The steps shown in FIG. 4 form a technique 400 for comparing claims data 326 and other types of received data, such as general ledger data 322, enrollment data 324, or the like. In step 402, claims data 326 is received, and can include any type of claims data 326 associated with a benefit plan, such as the examples shown in and discussed in connection with FIG. 3. Enrollment data 324 is received in step 404, and the received data are compared in step 406. Optionally, general ledger (GL) data 322 can be received. This GL data 322 can be received in place of or in addition to the enrollment data received in step 404. If GL data 322 is received, that data can be received with any other received data, such as claims data 326 received in step 402 and/or enrollment data 324 received in step 404.

For example, referring to FIG. 1, claims data 326 can be received from care providers 150, insurers 160, benefit plan members 180, or the like. That information, which can be received by an administrating entity by way of the network 110, and can be compared with enrollment data 324, which can be retrieved, for example, from data storage devices 116 within the local network 130, or from other sources, such as human resources 124. Similarly, GL data 322 can be received from data storage devices 116 connected to the local network 130 by way of the firewall/gateway 112, or it can be received from one or more devices within the finance 122 organization of the administrating entity.

Returning to FIG. 4, once the various types of received data are compared in step 406, a determination can be made in step 410, regarding whether the received claims data 326 corresponds to an enrolled member within a benefit plan for whom the claim is made. More specifically, the determination in step 410 can decide whether a claim received in step 402 corresponds to a member enrolled within a benefit plan, whose data can be received in step 404. This determination of step 410 can allow an administrating entity to deny payment for any claims for service to individuals not enrolled within the benefit plan. Once the determination of step 410 has been made, the result of that determination and the comparison of step 406 can be output in step 412. This result can be, for example, transmitted or broadcast to one or more organizations within the administrating entity via the local network 130 shown in FIG. 1. The result output in step 412 can include, for example, one or more dashboards displaying information useful to organizations within the administrating entity, such as the dashboards described in greater detail below.

Optionally, additional determinations can be made using the technique 400 shown in FIG. 4. For example, an optional determination 414 can be made regarding whether a claim corresponds to a GL entry, or to GL data 322 received in step 408. For example, in connection with monitoring compliance or risk assessment, it may be desirable to compare received claims data and/or received enrollment data 324 with GL data 322, to determine whether or not those sets of data match. Such determinations may be made in response to compliance requirements of various regulatory schemes, or can be used to generate notices to affected individuals or organizations if improper payment of claims is made. If such an optional determination 414 is made, the result output in step 412 can include information regarding that optional determination.

In addition to determining if claims correspond to enrolled members within a benefit plan in step 410, the technique 400 shown in FIG. 4 can also identify duplicate claims. For example, in the optional step 416 of the technique 400, claims previously paid for the same service (member, provider, date) can be identified, and can be output as part of the result output in step 412. For example, if it is determined in step 410 that a claim represents a service for which payment has already been made, that claim can be identified as a duplicate in optional step 416, and information concerning that duplicate claim can be output in step 412 for the convenience and information of the administrating entity.

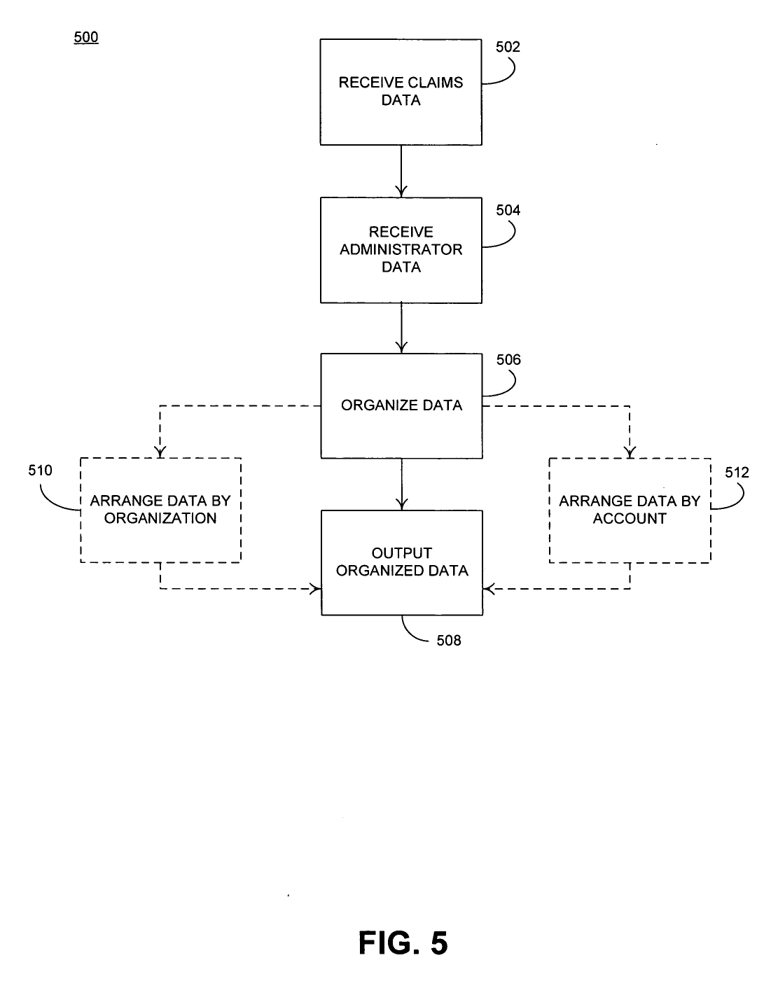

FIG. 5 is a flow diagram illustrating steps for organizing and displaying claims data and administrator data, according to an embodiment of the invention. The technique 500 shown in FIG. 5 includes a step of receiving claims data 502, and receiving administrator data in step 504. The data is organized in step 506. This organized data is output in step 508 and can be organized in step 506 in the form of one or more dashboards, for example. The information output in step 508, which can be output in the form of one or more dashboards, can be of interest to various individuals within an administrating entity (e.g., CFO, controller, assistant controller, benefits finance, benefits accounting, internal controls coordinator, VP of human resources, VP of benefits, VP of compensation, etc.). As will be described in greater detail below, several dashboards can be created to include useful information to individuals within an administrating entity, such as health benefits organized by account and/or organization level, employer costs by account and/or organization levels, or the like. Thus, as illustrated in FIG. 5, in addition to organizing data in step 506, data can optionally be organized by organization in optional step 510 and/or by account in optional step 512. This information can be used to create meaningful output in step 508. The information output in step 508 can be output by transmission or broadcast via the local network 130, for example, so that various organizations within an administrating entity can have access to the output.

Financial Dashboards

As mentioned above, one or more different “dashboards” can be created to display useful information to individuals or organizations within an administrating entity, or other organization associated with administration of benefits plan. For example, “dashboards” provided according to one or more embodiments of the invention can display useful information to such individuals or organizations in a convenient viewing configuration.

Health Benefits Dashboard by Vendor

One convenient dashboard for use by such individuals is a health benefits dashboard organized by vendor. For example, Table 1 below can be used to display health benefits actual dollars organized by vendor, which includes a monthly breakdown of headcount and actual forecast dollars by health benefits vendor, and can form part of a health benefits dashboard by vendor. It should be noted that, although no values are shown in Table 1 and Table 2, those tables can display dollar amounts when used in step 508 of FIG. 5 to output organized data.

TABLE 1
Health Benefits Actual Dollars by Vendor

| | Time Period | | | | | | | | | | | |
|---|---|---|---|---|---|---|---|---|---|---|---|---|
| Metrics | March | April | May | June | July | August | September | October | November | December | January | February |
| Actual | 2003 | 2003 | 2003 | 2003 | 2003 | 2003 | 2003 | 2003 | 2003 | 2003 | 2004 | 2004 |

# Members - Employees
Employer Paid Claims $
Employer ASO Fees $
Employer Premiums $
Employee Contribution $
Net Employer Cost $
Net Employer Cost % to
All Vendors
Employer Paid Claims per
employee per month $
Employer ASO Fees per
employee per month $
Employer Premiums per
employee per month $
Employee Contribution per
employee per month $
Net Employer Cost per employee
per month $

Similarly, Table 2 below shows health benefits forecast dollars by vendor. In other words, the dollars that would be displayed using a table like Table 1 are actual known dollars, while the dollars that would be displayed using a table like Table 2 would be forecast dollars, or dollars that are forecast to be spent in the future under a benefit plan, but which have not yet been spent. Table 2 can also be displayed as part of a health benefits dashboard.

TABLE 2
Health Benefits Forecast Dollars by Vendor

| | Time Period | | | | | | | | | | | |
|---|---|---|---|---|---|---|---|---|---|---|---|---|
| Metrics | March | April | May | June | July | August | September | October | November | December | January | February |
| Forecast | 2004 | 2004 | 2004 | 2004 | 2004 | 2004 | 2004 | 2004 | 2004 | 2004 | 2005 | 2005 |

# Members - Employees
Employer Paid Claims $
Employer ASO Fees $
Employer Premiums $
Employee Contribution $
Net Employer Cost $
Net Employer Cost % to
All Vendors
Employer Paid Claims per
employee per month $
Employer ASO Fees per
employee per month $
Employer Premiums per
employee per month $
Employee Contribution per
employee per month $
Net Employer Cost per employee
per month $

Definitions for the various metrics displayed in Table 1 and Table 2 are shown below in Table 3.

TABLE 3
Metric Definitions

| Metric Name | Definition |
|---|---|
| # Members - Employees | Shows the number of employees enrolled in a |
| | specific vendor and calendar month. |
| Employer Paid Claims $ | Shows the claims dollars paid by the employer, by |
| | vendor and calendar month. |
| Employer ASO Fees $ | Shows the administrative service only (ASO) fees |
| | paid by the employer, by vendor and calendar |
| | month. |
| Employer Premiums $ | Shows the premiums paid by the employer, by |
| | vendor and calendar month |
| Employee Contribution $ | Shows the employee payroll |
| | deduction/contribution by vendor and calendar |
| | month. |
| Net Employer Cost $ | (Employer Paid Claims Cost $ + Employer ASO |
| | Fees Cost $ + Employer Premiums Cost $) − Employee |
| | Contribution $ |
| Net Employer Cost % to All Vendors | Net Employer Cost $/Net Employer Cost $ across |
| | all vendors |
| Employer Paid Claims $ per employee per month $ | Employer Paid Claims Cost $/# Members - Employees |
| Employer ASO Fees $ per employee per month $ | Employer ASO Fees Cost $/# Members - Employees |
| Employer Premiums $ per employee per month $ | Employer Premiums Cost $/# Members - Employees |
| Employee Contribution per employee per month $ | Employee Payroll Deduction $/# Members - Employees |
| Net Employer Cost per employee per month $ | Net Employer Cost $/# Members - Employees |

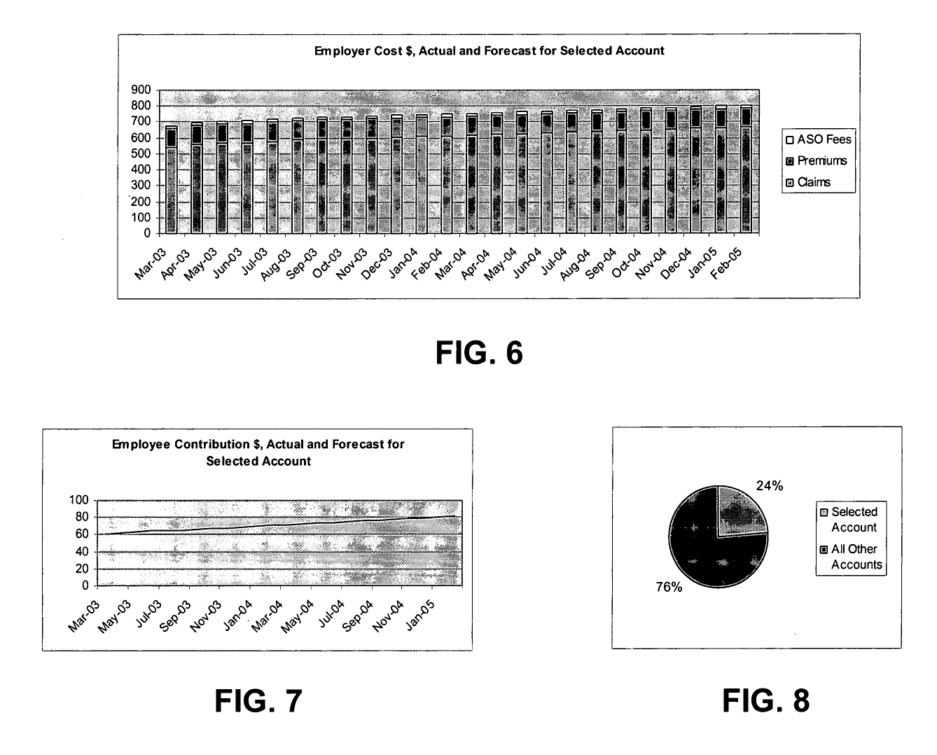

FIG. 6 is a bar chart illustrating actual costs and forecast costs for a particular vendor, according to an embodiment of the invention. In addition to displaying tabular data in the forms shown in Table 1 and Table 2 above, a health benefits dashboard organized by vendor can also display charts, such as the bar chart shown in FIG. 6. The bar chart shown in FIG. 6, illustrates the breakdown of benefits costs on a monthly basis for a specific, selected vendor. These costs are broken down into claims costs, premiums, and administration costs, or administrative services only (ASO) fees. The chart shown in FIG. 6 can be, for example, output in step 508 of FIG. 5.

FIG. 7 is a graph illustrating actual costs and forecast costs for a particular vendor, according to an embodiment of the invention. The graph shown in FIG. 7 illustrates the actual and forecast employee contribution dollars made over the same months illustrated in Tables 1 and 2 and in the bar chart of FIG. 6 and can be displayed as part of a health benefits dashboard organized by vendor, which can be output, for example, in step 508 of FIG. 5.

FIG. 8 is a pie chart illustrating actual costs and forecast costs for a particular vendor, according to an embodiment of the invention. The pie chart shown in FIG. 8 illustrates the percentage of all vendors that the selected vendor represents. Specifically, as shown in FIG. 8, the selected vendor (for which the bar chart of FIG. 6 and the graph of FIG. 7 are shown) is 24% of total vendors. The pie chart of FIG. 8 can be included as part of a health benefits dashboard and can be, for example, output in step 508 of FIG. 5.

Health Benefits Dashboard by Vendor and Organization Level

Another useful dashboard for individuals and organizations within an administrating entity is a health benefits dashboard by vendor and organization level. This dashboard breaks down benefits on a monthly basis and provides actual and forecast dollars by company organization level within each vendor. For example, costs associated with a specific organization can be tracked using tables similar to Tables 1 and 2 above, and information about such organization-level detail can be presented using a dashboard that includes a bar chart similar to the bar chart shown in FIG. 6, a graph similar to the graph illustrated in FIG. 7, and/or a pie chart similar to the pie chart illustrated in FIG. 8. This organization-level detail can be implemented with additional definitions, similar to those shown in Table 3, accounting for the additional breakdown into organization-level detail as well as vendor-level detail. Information presented in such a dashboard can be, for example, output in step 508 of FIG. 5.

Employer Cost Dashboard by Vendor and Organization Level

Another useful dashboard that can be used according to one or more embodiments of the invention is an employer cost dashboard organized by vendor and organization level. An example of this information is illustrated in Table 4 below, which includes an vendor, the various organization levels within the vendor that have information to be displayed, and the corresponding dollar amounts for various costs and expenses of interest, such as employer paid claims dollars, employer ASO fees dollars, and employer premiums dollars. Of course, the various employer-related dollar amounts shown in Table 4 can be generalized to include any dollar amounts associated with any entity administrating a benefits plan. Information presented in such a dashboard can be, for example, output in step 508 of FIG. 5.

TABLE 4
Employer Costs by Vendor and Organization Level

| | | Employer | | |
|---|---|---|---|---|
| | Organization | Paid | Employer ASO | Employer |
| Vendor | Level 3 | Claims $ | Fees $ | Premiums $ |
| Vendor 1 | Technical | $60,945,755 | $1,540,898 | $7,574,218 |
| | Center | | | |
| | Sales and | $58,201,006 | $1,327,778 | $9,290,523 |
| | Marketing | | | |
| | Administration | $63,861,140 | $1,854,205 | $7,904,695 |

Proportioning Actual General Ledger Data from Vendor to Vendor/Organization Level

Typically, financial entries in the general ledger are posted for specific health-benefits vendors. In order to enable Finance to break down the general ledger entry into dollars attributable to individual organization levels and still reconcile to the general ledger (in the context of charging back the organization levels for health-benefits spending), data can be proportioned into organization levels using two proportioning methods: proportioning by dollars from the claims data and proportioning by headcount from the enrollment data. Various metrics used in one or more of the dashboards described above can be proportioned according to one of these two methods. For example, employer paid claims dollars in the general ledger data can be proportioned according to dollars from the claims data, employer paid ASO fees dollars and employer premiums dollars can be proportioned according to headcount from the enrollment data. Thus, the values shown in the last two columns of Table 4 above can be proportioned according to headcount, while the values in the first column showing dollar amounts (employer-paid claims dollars) are proportioned by dollars instead of headcount.

Proportioning by dollars includes calculating the sum of the metric (e.g., employer-paid claims dollars) to be calculated for each vendor-organization level combination. The dollars used to calculate the sum are sourced from vendor claim feeds, such as communications via a network 110(shown in FIG. 1) from care providers 150 or insurers 160. Once the sum of the metric is calculated, a percentage to total for each vendor-organization level combination is calculated. To calculate this percentage, a ratio is used where the numerator is the metric at the vendor-organization level, and the denominator is the metric at the vendor level. Once the percent is calculated, it is applied to total values for the metric to create the proportions by vendor-organization level.

According to one or more embodiments of the invention, in some cases general ledger (GL) data 322 may be gathered monthly, while claims data 326 is gathered quarterly. In such situations, and where GL data 322 includes forecast dollars, periods will exist for which GL data 322 is available but claims data 326 is not yet available. Thus, in such situations, when claims data is available for a paid month, the claims data 326 for that month will be used to generate the proportions for the same month of GL data 322. On the other hand, when claims data 326 is not available for a paid month, the claims data 326 for the most recent three paid months will be used together to generate proportions for the GL data 322.

In contrast to proportioning by dollars, proportioning can also be performed based on headcount. When proportioning by headcount, the number of members or employees for each vendor-organization level combination is calculated. This data can be sourced from an enrollment feed, such as information received from the enrollment data storage device 324 shown in FIG. 3. Once the number of members or employees is calculated, the percent to total for each vendor and for each vendor-organization level combination is calculated. The numerator in this calculation is the number of members or employees at the vendor-organization level, and the denominator is the sum of the number of members or employees at each organization level within the vendor. The percent calculated in this manner is then applied to the total values for the metric to create the proportions of the metric by vendor-organization level.

According to one or more embodiments of the invention, GL data 322 will be gathered monthly, and enrollment data 324 will be gathered quarterly. Because of this, and because the GL tables contain forecast dollars, as with the claims data 326 described above, there may be periods for which GL data 322 is available but enrollment data 324 is not yet available. When enrollment data 324 is available for a month, the enrollment data 324 is used for that month to generate the proportions for the same month of GL data 322. When enrollment data 324 is not available for a month, the enrollment data 324 for the most recent month is used to generate proportions for the GL data 322.

In addition to displaying data in formats useful to an administrating entity or individuals or organizations within such an entity (e.g., dashboard format) one or more embodiments of the invention provide techniques for financial management of benefit plans, which can include, for example, estimation of reserves available. These financial management techniques can make use of various data forecasting capabilities. To produce forecast data, one or more forecast algorithms may be used. These algorithms may require the input data to be prepared for use in such algorithms or financial management techniques.

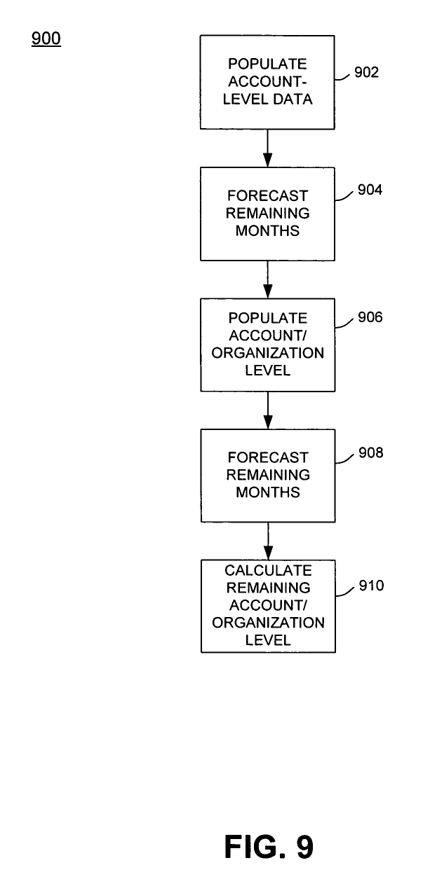

FIG. 9 is a flow diagram illustrating steps for estimating health-benefits forecasts, according to an embodiment of the invention. The technique 900 shown in FIG. 9 can be used to prepare data for use in forecasting algorithms, or the like. First, in step 902, account-level data is populated for one or more metrics. For example, according to one or more embodiments of the invention, five metrics can be populated using all available data for the past 12 months in step 902. These five metrics include account-level data including the number of members or employees (which can be sourced from enrollment data 324), the employer paid claims dollars (which can be sourced from GL data 322), employer ASO fees dollars (which can be sourced from GL data 322), employer premiums dollars (which can be sourced from GL data 322), and employee contribution dollars (which can be sourced from enrollment data 324). The various metrics containing data sourced from enrollment can be mapped to one or more accounts so that the account-level data desired to be used in step 902 can be accessed.

Once the account-level data has been populated in step 902, the remaining months of account-level data is forecast (i.e., months for which actual data do not exist) in step 904. This can be accomplished, for example, by using a forecast algorithm, or one or more estimation techniques described below. Generally, the more actual data that can be used to form a trend for forecasting, produces a more accurate forecast result. For example, if a longer period of time with actual data can be used to forecast future data, that longer period is beneficial for the quality of the forecast. Similarly, if more pieces of data are available to create such a forecast, the forecast will be more accurate. Thus, according to one or more embodiments of the invention, several months (e.g., four months) of actual data should be available prior to creating a forecast. Similarly, to produce accurate results for members within an account, a reasonably large number of member months (e.g., 65,000 member months) should exist in an account for the most recent period of actual data (e.g., the preceding 12 months) to perform forecasting accurately. To ensure the most accurate results, a combination of a minimum number of months of actual data and a minimum number of member months can both exist prior to performing any forecasting, (e.g., a forecast algorithm or a financial management technique, such as those described below). The exact constraints can vary according to the desires of the users of such a system, or the desired accuracy of such a system.

Once the remaining months have been forecast in step 904 of FIG. 9, the account-organization level is populated with actual data in step 906. For example, of the sample types of data populated in step 902 described above, the number of members or employees and the employee contribution dollars can be populated at the account-organization level using actual data in step 906. In step 906, this data can be populated for the past 12 months, or some other desired period.

Once the account-organization level data has been populated in step 906, data for the remaining months of the same account-organization level data can be forecast in step 908. As described above in connection with step 904, this account-organization level forecasting can be constrained using one or more constraints on available actual data, and various forecasting techniques can be used, such as a forecast algorithm, or various financial management techniques, which will be described in greater detail below.

Once the remaining months of account-organization level data has been forecast in step 908, the metrics not previously calculated or populated in step 906 can be calculated in step 910. For example, of the sample metrics discussed above in connection with step 902, the remaining three metrics (i.e., not including the two example metrics populated in step 906) can be calculated from the existing account-level data from step 904. The existing account-level data includes both actual and forecast data. The remaining three account-organization level metrics can be calculated using a proportioning algorithm, such as the techniques described above used to proportion by dollars or by headcount.

Financial Management/Reserves Estimation Techniques

As mentioned above, several financial management techniques exist for estimating reserves under a health benefit plan. These include a claims lag report method, a earned premium method, and an iterative method. One useful construct for several of these methods is a “claim lag triangle.” The technique used to create a claim lag triangle is described in greater detail below. The claim lag triangle and the various techniques used to estimate reserves are useful in estimating the total incurred claims that are incurred but not reported.

Claims Lag Triangle

Table 5 below illustrates a claim lag triangle, which is a table of values showing incurred or service months on the horizontal and calendar months or paid months on the vertical. At the bottom of Table 5, the number of members within the benefit plan for each incurred or service month is shown. These numbers can be used for reserves estimation.

TABLE 5
Claim Lag Triangle

| Calendar | Incurred/Service Month | | | | | | | | | | | | |
|---|---|---|---|---|---|---|---|---|---|---|---|---|---|
| Month | May-01 | Jun-01 | Jul-01 | Aug-01 | Sep-01 | Oct-01 | Nov-01 | Dec-01 | Jan-02 | Feb-02 | Mar-02 | Apr-02 | May-02 |
| May-01 | 447,214 | | | | | | | | | | | | |
| Jun-01 | 538,819 | 452,494 | | | | | | | | | | | |
| Jul-01 | 271,003 | 681,641 | 405,550 | | | | | | | | | | |
| Aug-01 | 279,777 | 204,624 | 660,011 | 437,787 | | | | | | | | | |
| Sep-01 | 21,122 | 200,106 | 231,426 | 690,135 | 417,387 | | | | | | | | |
| Oct-01 | 109,798 | 17,748 | 107,810 | 367,778 | 617,342 | 474,083 | | | | | | | |
| Nov-01 | 9,762 | 17,997 | 65,640 | 53,168 | 256,459 | 682,192 | 407,673 | | | | | | |
| Dec-01 | 12,859 | 5,258 | 22,049 | 74,421 | 85,579 | 196,974 | 625,153 | 442,587 | | | | | |
| Jan-02 | 2,369 | 3,105 | 17,653 | 31,236 | 66,469 | 102,279 | 419,248 | 675,124 | 454,181 | | | | |
| Feb-02 | −5,365 | 3,103 | 5,212 | 14,744 | 5,988 | 65,293 | 71,569 | 231,065 | 608,263 | 380,028 | | | |
| Mar-02 | 87,211 | 1,852 | 8,725 | 7,762 | 15,750 | 210,728 | 33,996 | 96,288 | 383,807 | 674,512 | 423,140 | | |
| Apr-02 | 763 | 3,969 | 3,390 | 4,699 | 4,317 | 15,866 | 25,843 | 10,388 | 154,518 | 182,944 | 709,767 | 429,631 | |
| May-02 | 12,861 | 2,635 | −618 | 1,567 | 5,880 | 7,862 | 3,088 | 7,124 | 131,772 | 50,315 | 191,327 | 698,883 | 429,656 |
| # Members for | 17,614 | 17,644 | 17,549 | 17,515 | 17,435 | 17,199 | 16,772 | 16,677 | 18,505 | 18,279 | 18,245 | 18,093 | 18,058 |
| reserves | | | | | | | | | | | | | |
| estimation | | | | | | | | | | | | | |

The claims lag triangle shown above in Table 5 can be used to estimate reserves in a claims lag report method, a earned premium method, and an iterative method. Each of these methods is described in greater detail below. In using the various methods described below to estimate reserves, it can be useful to have many months of paid claims to increase accuracy. Specifically, according to one or more embodiments of the invention, thirteen months of previously paid claims can be used to obtain greater statistical accuracy, as by some estimates most benefit plans paid 99% or more of all claims within the first twelve months after being incurred. According to one or more embodiments of the invention, the number of members used in the various estimation techniques described below can include a total number of members, or can count an adult as a full member and a child as a half member.

Claims Lag Report Method for Estimating Reserves

The claims lag report method is a mathematical algorithm that estimates incurred but not reported claims (i.e., reserves) by producing and using a set of completion factors. The completion factors describe the percentage of incurred claims dollars that have been paid in each month after the claims have been incurred. It should be noted, that the first several steps described below in connection with the claims lag report method for estimating reserves can also be used in connection with other techniques for estimating reserves described below.

In the claims lag report method for estimating reserves, the claim lag triangle shown in Table 5 is rearranged in Table 6, such that claims incurred are shown with respect to the number of months since the incurred month that they are paid. More specifically, the “calendar month” on the left-hand side of Table 6 has a value ranging from 0 to 12, indicating the number of months after the incurred month in which the claim was paid. Thus, the values in the first entry location under May-01, or the entry corresponding to calendar month 0 corresponds to the claims incurred and paid in May-01. Likewise, the values in the the second entry location in that column represent claims incurred in May-01 and paid in the first month after May-01 (i.e., paid in June of 2001).

TABLE 6
Rearranged Claim Lag Triangle

| Cal- | | | | | | | | | | | | | |
|---|---|---|---|---|---|---|---|---|---|---|---|---|---|
| endar | Incurred/Service Month | | | | | | | | | | | | |
| Month | May-01 | Jun-01 | Jul-01 | Aug-01 | Sep-01 | Oct-01 | Nov-01 | Dec-01 | Jan-02 | Feb-02 | Mar-02 | Apr-02 | May-02 |
| 0 | 447,214 | 452,494 | 405,550 | 437,787 | 417,387 | 474,083 | 407,673 | 442,587 | 454,181 | 380,028 | 423,140 | 429,631 | 429,656 |
| 1 | 538,819 | 681,641 | 660,011 | 690,135 | 617,342 | 682,192 | 625,153 | 675,124 | 608,263 | 674,512 | 709,767 | 698,883 | |
| 2 | 271,003 | 204,624 | 231,426 | 367,778 | 256,459 | 196,974 | 419,248 | 231,065 | 383,807 | 182,944 | 191,327 | | |
| 3 | 279,777 | 200,106 | 107,810 | 53,168 | 85,579 | 102,279 | 71,569 | 96,288 | 154,518 | 50,315 | | | |
| 4 | 21,122 | 17,748 | 65,640 | 74,421 | 66,469 | 65,293 | 33,996 | 10,388 | 131,772 | | | | |
| 5 | 109,798 | 17,997 | 22,049 | 31,236 | 5,988 | 210,728 | 25,843 | 7,124 | | | | | |
| 6 | 9,762 | 5,258 | 17,653 | 14,744 | 15,750 | 15,866 | 3,088 | | | | | | |
| 7 | 12,859 | 3,105 | 5,212 | 7,762 | 4,317 | 7,862 | | | | | | | |
| 8 | 2,369 | 3,103 | 8,725 | 4,699 | 5,880 | | | | | | | | |
| 9 | −5,365 | 1,852 | 3,390 | 1,567 | | | | | | | | | |
| 10 | 87,211 | 3,969 | −618 | | | | | | | | | | |
| 11 | 763 | 2,635 | | | | | | | | | | | |
| 12 | 12,861 | | | | | | | | | | | | |

Table 7 below shows cumulative claims for each incurred month. In other words, the dollar amounts shown in each successive calendar month include a cumulative total of all previous months from Table 6. Thus, the second value under May-01 in Table 7 is the total of the first and second values under that same heading in Table 6. The third entry under May-01 in Table 7 includes the sum of the first three entries under May-01 in Table 6, and so on.

TABLE 7
Cumulative Claims for Incurred Month

| Calendar | Incurred/Service Month | | | | | | |
|---|---|---|---|---|---|---|---|
| Month | May-01 | Jun-01 | Jul-01 | Aug-01 | Sep-01 | Oct-01 | Nov-01 |
| 0 | 447,214 | 452,494 | 405,550 | 437,787 | 417,387 | 474,083 | 407,673 |
| 1 | 986,033 | 1,134,135 | 1,065,561 | 1,127,922 | 1,034,729 | 1,156,275 | 1,032,826 |
| 2 | 1,257,036 | 1,338,759 | 1,296,987 | 1,495,700 | 1,291,188 | 1,353,249 | 1,452,074 |
| 3 | 1,536,813 | 1,538,865 | 1,404,797 | 1,548,868 | 1,376,767 | 1,455,528 | 1,523,643 |
| 4 | 1,557,935 | 1,556,613 | 1,470,437 | 1,623,289 | 1,443,236 | 1,520,821 | 1,557,639 |
| 5 | 1,667,733 | 1,574,610 | 1,492,486 | 1,654,525 | 1,449,224 | 1,731,549 | 1,583,482 |
| 6 | 1,677,495 | 1,579,868 | 1,510,139 | 1,669,269 | 1,464,974 | 1,747,415 | 1,586,570 |
| 7 | 1,690,354 | 1,582,973 | 1,515,351 | 1,677,031 | 1,469,291 | 1,755,277 | |
| 8 | 1,692,723 | 1,586,076 | 1,524,076 | 1,681,730 | 1,475,171 | | |
| 9 | 1,687,358 | 1,587,928 | 1,527,466 | 1,683,297 | | | |
| 10 | 1,774,569 | 1,591,897 | 1,526,848 | | | | |
| 11 | 1,775,332 | 1,594,532 | | | | | |
| 12 | 1,788,193 | | | | | | |

| Calendar | Incurred/Service Month | | | | | |
|---|---|---|---|---|---|---|
| Month | Dec-01 | Jan-02 | Feb-02 | Mar-02 | Apr-02 | May-02 |
| 0 | 442,587 | 454,181 | 380,028 | 423,140 | 429,631 | 429,656 |
| 1 | 1,117,711 | 1,062,444 | 1,054,540 | 1,132,907 | 1,128,154 | |
| 2 | 1,348,776 | 1,446,251 | 1,237,484 | 1,324,234 | | |
| 3 | 1,445,064 | 1,600,769 | 1,287,799 | | | |
| 4 | 1,455,452 | 1,732,541 | | | | |
| 5 | 1,462,576 | | | | | |
| 6 | | | | | | |
| 7 | | | | | | |
| 8 | | | | | | |
| 9 | | | | | | |
| 10 | | | | | | |
| 11 | | | | | | |
| 12 | | | | | | |

Table 8 shows paid claim ratios for each incurred or service month. The paid claim ratios are calculated using the cumulative claims totals from Table 7. For example, each paid claim ratio is calculated by dividing the cumulative claim total for the month during which the claim ratio is to be calculated by the cumulative total for the following incurred month. In other words, if the paid claim ratio is to be calculated for month M, then the paid claim ratio for that month would be the ratio of the cumulative total for that month (month M) and the following month (month M+1).

TABLE 8
Paid Claim Ratios

| Calendar | Incurred/Service Month | | | | | | | | | | | | |
|---|---|---|---|---|---|---|---|---|---|---|---|---|---|
| Month | May-01 | Jun-01 | Jul-01 | Aug-01 | Sep-01 | Oct-01 | Nov-01 | Dec-01 | Jan-02 | Feb-02 | Mar-02 | Apr-02 | May-02 |
| 0 | 0.454 | 0.399 | 0.381 | 0.388 | 0.403 | 0.410 | 0.395 | 0.396 | 0.427 | 0.360 | 0.373 | 0.381 | |
| 1 | 0.784 | 0.847 | 0.822 | 0.754 | 0.801 | 0.854 | 0.711 | 0.829 | 0.735 | 0.852 | 0.856 | | |
| 2 | 0.818 | 0.870 | 0.923 | 0.966 | 0.938 | 0.930 | 0.953 | 0.933 | 0.903 | 0.961 | | | |
| 3 | 0.986 | 0.989 | 0.955 | 0.954 | 0.954 | 0.957 | 0.978 | 0.993 | 0.924 | | | | |
| 4 | 0.934 | 0.989 | 0.985 | 0.981 | 0.996 | 0.878 | 0.984 | 0.995 | | | | | |
| 5 | 0.994 | 0.997 | 0.988 | 0.991 | 0.989 | 0.991 | 0.998 | | | | | | |
| 6 | 0.992 | 0.998 | 0.997 | 0.995 | 0.997 | 0.996 | | | | | | | |
| 7 | 0.999 | 0.998 | 0.994 | 0.997 | 0.996 | | | | | | | | |
| 8 | 1.003 | 0.999 | 0.998 | 0.999 | | | | | | | | | |
| 9 | 0.951 | 0.998 | 1.000 | | | | | | | | | | |
| 10 | 1.000 | 0.998 | | | | | | | | | | | |
| 11 | 0.993 | | | | | | | | | | | | |

Table 9 shows weighted average ratios calculated for each calendar month using the paid claim ratios of Table 8. These are calculated as the average of all the completion factors for a calendar month by Incurred/Service month.

TABLE 9
Weighted Average Ratios

| Calendar | Weighted |
|---|---|
| Month | Ratio |
| 0 | 0.397 |
| 1 | 0.805 |
| 2 | 0.920 |
| 3 | 0.965 |
| 4 | 0.968 |
| 5 | 0.993 |
| 6 | 0.996 |
| 7 | 0.997 |
| 8 | 1.000 |
| 9 | 0.983 |
| 10 | 0.999 |
| 11 | 0.993 |

Table 10 below shows completion factors, which are calculated using the weighted average ratio shown above, along with other data shown above. The completion factors shown in Table 10 indicate the ratio of total cumulative payments through a given calendar month to the total payments that will be paid for claims incurred within the incurred month (i.e., the calendar month 0). For example, the completion factors shown in Table 10 indicate that one month after the incurred month, only about 66.3% of all claims incurred within the incurred month have been paid. Table 10 also shows the number increases to about 97.5% by the eighth month after the incurred month.

According to one or more embodiments of the invention, when calculating completion factors, a completion factor of 1.00 can be assigned for the first incurred or service month in the claim lag triangle in which the percentage of paid claims is 100%, and any following months. Additionally, according to one or more embodiments of the invention, if the percentage of paid claims remains 99% for the last month of the completion factor table, a completion factor of 0.999 can be assigned.

TABLE 10
Completion Factors

| Calendar | Completion |
|---|---|
| Month | Factor |
| 0 | 0.263 |
| 1 | 0.663 |
| 2 | 0.824 |
| 3 | 0.896 |
| 4 | 0.929 |
| 5 | 0.960 |
| 6 | 0.967 |
| 7 | 0.971 |
| 8 | 0.975 |
| 9 | 0.975 |
| 10 | 0.992 |
| 11 | 0.993 |
| 12 | 1.000 |

Table 11 shows reserves calculated using the claims lag report method. Using the completion factors, the total estimated incurred claims can be calculated, and the difference between the incurred claims and the amount already paid can form an estimate of incurred but not reported claims, or reserve dollars. As expected, the number of reserve dollars required decreases as the number of calendar months from the incurred month increases. Based on an assumed completion factor of 1.000 in the 12^{th} calendar months after the incurred service month, no reserves would be required at or beyond 12 months from the incurred month.

TABLE 11
Reserves Calculated Using Claims Lag Report Method

| Payroll | 2,465,936 | 2,470,112 | 2,456,842 | 2,452,084 | 2,440,961 | 2,407,898 | 2,348,137 |
|---|---|---|---|---|---|---|---|
| Deduction | | | | | | | |
| Total Paid | 1,788,193 | 1,594,532 | 1,526,848 | 1,683,297 | 1,475,171 | 1,755,277 | 1,586,570 |
| Amount | | | | | | | |
| (Employer and | | | | | | | |
| Member) | | | | | | | |
| Medical $ | | | | | | | |
| Completion | 1.000 | 0.993 | 0.992 | 0.975 | 0.975 | 0.971 | 0.967 |
| Factors | | | | | | | |
| Estimated | 1,788,193 | 1,606,083 | 1,539,513 | 1,726,772 | 1,513,697 | 1,806,844 | 1,640,029 |
| Incurred | | | | | | | |
| Claims $ | | | | | | | |
| Estimated | 0 | 11,551 | 12,665 | 43,475 | 38,526 | 51,567 | 53,459 |
| Incurred but | | | | | | | |
| not Reported | | | | | | | |
| Claims | | | | | | | |
| (Reserve) $ | | | | | | | |
| | Payroll | 2,334,733 | 2,960,774 | 2,924,687 | 2,919,171 | 2,894,904 | 2,889,292 |
| | Deduction | | | | | | |
| | Total Paid | 1,462,576 | 1,732,541 | 1,287,799 | 1,324,234 | 1,128,514 | 429,656 |
| | Amount | | | | | | |
| | (Employer and | | | | | | |
| | Member) | | | | | | |
| | Medical $ | | | | | | |
| | Completion | 0.960 | 0.929 | 0.896 | 0.824 | 0.663 | 0.263 |
| | Factors | | | | | | |
| | Estimated | 1,523,085 | 1,864,452 | 1,436,830 | 1,606,562 | 1,701,383 | 1,633,127 |
| | Incurred | | | | | | |
| | Claims $ | | | | | | |
| | Estimated | 60,509 | 131,911 | 149,031 | 282,328 | 572,869 | 1,203,471 |
| | Incurred but | | | | | | |
| | not Reported | | | | | | |
| | Claims | | | | | | |
| | (Reserve) $ | | | | | | |

Earned Premium Method for Estimating Reserves

The earned premium method derives monthly incurred claims by multiplying an average claim rate with the monthly earned premium. The weighting mechanism used to determine the average claim rate are the completion factors from the claims lag report method (shown in Table 10).

Table 12 shows values from the claims lag report method that are used as input for the earned premium method of estimating reserves.

TABLE 12
Values from Claims Lag Report Method for Estimating Reserves

| | Incurred/Service Month | | | | | | |
|---|---|---|---|---|---|---|---|
| | May-01 | Jun-01 | Jul-01 | Aug-01 | Sep-01 | Oct-01 | Nov-01 |
| Number of | 1 | 2 | 3 | 4 | 5 | 6 | 7 |
| Month | | | | | | | |
| Employer | 1,788,193 | 1,594,532 | 1,526,848 | 1,683,297 | 1,475,171 | 1,755,277 | 1,586,570 |
| Paid | | | | | | | |
| Amount | | | | | | | |
| Medical $ | | | | | | | |
| Completion | 1.000 | 0.993 | 0.992 | 0.975 | 0.975 | 0.971 | 0.967 |
| Factors | | | | | | | |
| # Members | 17,614 | 17,644 | 17,549 | 17,515 | 17,435 | 17,199 | 16,772 |
| for | | | | | | | |
| reserves | | | | | | | |
| estimation | | | | | | | |

| | Incurred/Service Month | | | | | |
|---|---|---|---|---|---|---|
| | Dec-01 | Jan-02 | Feb-02 | Mar-02 | Apr-02 | May-02 |
| Number of | 8 | 9 | 10 | 11 | 12 | 13 |
| Month | | | | | | |
| Employer | 1,462,576 | 1,732,541 | 1,287,799 | 1,324,234 | 1,128,514 | 429,656 |
| Paid | | | | | | |
| Amount | | | | | | |
| Medical $ | | | | | | |
| Completion | 0.960 | 0.929 | 0.897 | 0.825 | 0.663 | 0.263 |
| Factors | | | | | | |
| # Members | 16,677 | 18,505 | 18,279 | 18,245 | 18,093 | 18,058 |
| for | | | | | | |
| reserves | | | | | | |
| estimation | | | | | | |

Table 13 below shows an input claim rate, which is calculated by first determining an incurred claims amount, also shown in Table 13. The incurred claims are calculated by dividing the total amount paid (which includes amounts from employer and employee) medical dollars by the completion factors. The input claim rate is then calculated by dividing the incurred claims by the number of members.

TABLE 13
Input Claim Rate

| | Incurred/Service Month | | | | | | |
|---|---|---|---|---|---|---|---|
| | May-01 | Jun-01 | Jul-01 | Aug-01 | Sep-01 | Oct-01 | Nov-01 |
| Number of | 1 | 2 | 3 | 4 | 5 | 6 | 7 |
| Month | | | | | | | |
| Employer | 1,788,193 | 1,594,532 | 1,526,848 | 1,683,297 | 1,475,171 | 1,755,277 | 1,586,570 |
| Paid Amount | | | | | | | |
| Medical $ | | | | | | | |
| Completion | 1.000 | 0.993 | 0.992 | 0.975 | 0.975 | 0.971 | 0.967 |
| Factors | | | | | | | |
| Incurred | 1,788,193 | 1,606,083 | 1,539,513 | 1,726,772 | 1,513,697 | 1,806,844 | 1,640,029 |
| Claims | | | | | | | |
| # Members | 17,614 | 17,644 | 17,549 | 17,515 | 17,435 | 17,199 | 16,772 |
| for reserves | | | | | | | |
| estimation | | | | | | | |
| Input Claim | 101.521 | 91.027 | 87.727 | 98.588 | 86.819 | 105.055 | 97.784 |
| Rate | | | | | | | |

| | Incurred/Service Month | | | | | |
|---|---|---|---|---|---|---|
| | Dec-01 | Jan-02 | Feb-02 | Mar-02 | Apr-02 | May-02 |
| Number of | 8 | 9 | 10 | 11 | 12 | 13 |
| Month | | | | | | |
| Employer | 1,462,576 | 1,732,541 | 1,287,799 | 1,324,234 | 1,128,514 | 429,656 |
| Paid Amount | | | | | | |
| Medical $ | | | | | | |
| Completion | 0.960 | 0.929 | 0.897 | 0.825 | 0.663 | 0.263 |
| Factors | | | | | | |
| Incurred | 1,523,085 | 1,864,452 | 1,435,812 | 1,606,073 | 1,701,641 | 1,631,145 |
| Claims | | | | | | |
| # Members | 16,677 | 18,505 | 18,279 | 18,245 | 18,093 | 18,058 |
| for reserves | | | | | | |
| estimation | | | | | | |
| Input Claim | 91.328 | 100.754 | 78.550 | 88.028 | 94.050 | 90.328 |
| Rate | | | | | | |

Table 14 shows monthly weights, which are calculated by multiplying the number of members by the completion factors to determine a monthly composite. Each monthly composite is then divided by the total composite to calculate monthly weights.

TABLE 14
Monthly Weights

| | Incurred/Service Month | | | | | | |
|---|---|---|---|---|---|---|---|
| | May-01 | Jun-01 | Jul-01 | Aug-01 | Sep-01 | Oct-01 | Nov-01 |
| Number of | 1 | 2 | 3 | 4 | 5 | 6 | 7 |
| Month | | | | | | | |
| Completion | 1.000 | 0.993 | 0.992 | 0.975 | 0.975 | 0.971 | 0.967 |
| Factors | | | | | | | |
| # Members | 17,614 | 17,644 | 17,549 | 17,515 | 17,435 | 17,199 | 16,772 |
| for | | | | | | | |
| reserves | | | | | | | |
| estimation | | | | | | | |
| Monthly | 17,614 | 17,517 | 17,405 | 17,074 | 16,991 | 16,708 | 16,225 |
| Composite | | | | | | | |
| Monthly | 0.088 | 0.087 | 0.087 | 0.085 | 0.085 | 0.083 | 0.081 |
| Weights | | | | | | | |
| | Incurred/Service Month | | | | | | |
| | Dec-01 | Jan-02 | Feb-02 | Mar-02 | Apr-02 | May-02 | Total |
| Number of | 8 | 9 | 10 | 11 | 12 | 13 | |
| Month | | | | | | | |
| Completion | 0.960 | 0.929 | 0.897 | 0.825 | 0.663 | 0.263 | |
| Factors | | | | | | | |
| # Members | 16,677 | 18,505 | 18,279 | 18,245 | 18,093 | 18,058 | 229,585 |
| for | | | | | | | |
| reserves | | | | | | | |
| estimation | | | | | | | |
| Monthly | 16,014 | 17,196 | 16,395 | 15,043 | 11,999 | 4,757 | 200,938 |
| Composite | | | | | | | |
| Monthly | 0.080 | 0.086 | 0.082 | 0.075 | 0.060 | 0.024 | 1.000 |
| Weights | | | | | | | |

Table 15 shows weighted input loss ratios, which are calculated for each month. The weighted input loss ratio is calculated by raising each input claim rate to the power of the corresponding monthly weight. Also shown in Table 15 is a calculation of all of the weighted input loss ratios.

TABLE 15
Weighted Input Loss Ratio

| | Incurred/Service Month | | | | | | | | | | | | | |
|---|---|---|---|---|---|---|---|---|---|---|---|---|---|---|
| | May-01 | Jun-01 | Jul-01 | Aug-01 | Sep-01 | Oct-01 | Nov-01 | Dec-01 | Jan-02 | Feb-02 | Mar-02 | Apr-02 | May-02 | Product |
| Number of | 1 | 2 | 3 | 4 | 5 | 6 | 7 | 8 | 9 | 10 | 11 | 12 | 13 | |
| Month | | | | | | | | | | | | | | |
| Input | 101.521 | 91.027 | 87.727 | 98.588 | 86.819 | 105.055 | 97.784 | 91.328 | 100.754 | 78.550 | 88.028 | 94.050 | 90.328 | |
| Claim Rate | | | | | | | | | | | | | | |
| Monthly | 0.088 | 0.087 | 0.087 | 0.085 | 0.085 | 0.083 | 0.081 | 0.080 | 0.086 | 0.082 | 0.075 | 0.060 | 0.024 | |
| Weights | | | | | | | | | | | | | | |
| Weighted Input | 1.499 | 1.482 | 1.473 | 1.477 | 1.459 | 1.473 | 1.448 | 1.433 | 1.484 | 1.428 | 1.398 | 1.312 | 1.112 | 93.147 |
| Loss | | | | | | | | | | | | | | |
| Ratio | | | | | | | | | | | | | | |

Table 16 shows the output claim rate. This is the product of the weighted input loss ratio by incurred/service month and is calculated by multiplying the weighted input loss ratios for all incurred/service months.

TABLE 16
Output Claim Rate

| | Incurred/Service Month | | | | | | | | | | | | |
|---|---|---|---|---|---|---|---|---|---|---|---|---|---|
| | May-01 | Jun-01 | Jul-01 | Aug-01 | Sep-01 | Oct-01 | Nov-01 | Dec-01 | Jan-02 | Feb-02 | Mar-02 | Apr-02 | May-02 |
| Number of | 1 | 2 | 3 | 4 | 5 | 6 | 7 | 8 | 9 | 10 | 11 | 12 | 13 |
| Month | | | | | | | | | | | | | |
| Base | 1.000 | 1.000 | 1.000 | 1.000 | 1.000 | 1.000 | 1.000 | 1.000 | 1.000 | 1.000 | 1.000 | 1.000 | 1.000 |
| Indicator | | | | | | | | | | | | | |
| Result | 0.500 | 0.500 | 0.500 | 0.500 | 0.500 | 0.500 | 0.500 | 0.500 | 0.500 | 0.500 | 0.500 | 0.500 | 0.500 |
| Indicator | | | | | | | | | | | | | |
| Annual | 0.00% | 0.00% | 0.00% | 0.00% | 0.00% | 0.00% | 0.00% | 0.00% | 0.00% | 0.00% | 0.00% | 0.00% | 0.00% |
| Trend | | | | | | | | | | | | | |
| Monthly | 0.00% | 0.00% | 0.00% | 0.00% | 0.00% | 0.00% | 0.00% | 0.00% | 0.00% | 0.00% | 0.00% | 0.00% | 0.00% |
| Trend | | | | | | | | | | | | | |
| Output | 93.147 | 93.147 | 93.147 | 93.147 | 93.147 | 93.147 | 93.147 | 93.147 | 93.147 | 93.147 | 93.147 | 93.147 | 93.147 |
| Claim Rate | | | | | | | | | | | | | |

Table 17 shows the average claim rate. This represents a weighting of the input and output claim rate, weighted by the input claim rate and one minus the completion factor for the output claim rate.

TABLE 17
Average Claim Rate

| | Incurred/Service Month | | | | | | | | | | | | |
|---|---|---|---|---|---|---|---|---|---|---|---|---|---|
| | May-01 | Jun-01 | Jul-01 | Aug-01 | Sep-01 | Oct-01 | Nov-01 | Dec-01 | Jan-02 | Feb-02 | Mar-02 | Apr-02 | May-02 |
| Number of | 1 | 2 | 3 | 4 | 5 | 6 | 7 | 8 | 9 | 10 | 11 | 12 | 13 |
| Month | | | | | | | | | | | | | |
| Input Claim | 101.521 | 91.027 | 87.727 | 98.588 | 86.819 | 105.055 | 97.784 | 91.328 | 100.754 | 78.550 | 88.028 | 94.050 | 90.328 |
| Rate | | | | | | | | | | | | | |
| Output | 93.147 | 93.147 | 93.147 | 93.147 | 93.147 | 93.147 | 93.147 | 93.147 | 93.147 | 93.147 | 93.147 | 93.147 | 93.147 |
| Claim Rate | | | | | | | | | | | | | |
| Completion | 1.000 | 0.993 | 0.992 | 0.975 | 0.975 | 0.971 | 0.967 | 0.960 | 0.929 | 0.897 | 0.825 | 0.663 | 0.263 |
| Factors | | | | | | | | | | | | | |
| Average | 101.521 | 91.042 | 87.771 | 98.451 | 86.981 | 104.715 | 97.633 | 91.401 | 100.216 | 80.055 | 88.926 | 93.746 | 92.405 |
| Claim Rate | | | | | | | | | | | | | |

Table 18 shows estimated reserves, which are calculated as the estimated incurred claims minus the paid claims by incurred/service month. The estimated incurred claims is the number of members multiplied by the average claim rate.

TABLE 18
Estimated Reserves

| | Incurred/Service Month | | | | | | |
|---|---|---|---|---|---|---|---|
| Calendar Month | May-01 | Jun-01 | Jul-01 | Aug-01 | Sep-01 | Oct-01 | Nov-01 |
| Number of | 1 | 2 | 3 | 4 | 5 | 6 | 7 |
| Month | | | | | | | |
| # | 17,614 | 17,644 | 17,549 | 17,515 | 17,435 | 17,199 | 16,772 |
| Members | | | | | | | |
| for | | | | | | | |
| reserves | | | | | | | |
| estimation | | | | | | | |
| Average | 101.521 | 91.042 | 87.771 | 98.451 | 86.981 | 104.715 | 97.633 |
| Claim | | | | | | | |
| Rate | | | | | | | |
| Estimated | 1,788,193 | 1,606,352 | 1,540,295 | 1,724,372 | 1,516,505 | 1,800,999 | 1,637,494 |
| Incurred | | | | | | | |
| Claims $ | | | | | | | |
| Estimated | 0 | 11,820 | 13,447 | 41,075 | 41,334 | 45,722 | 50,924 |
| Incurred | | | | | | | |
| but not | | | | | | | |
| Reported | | | | | | | |
| Claims | | | | | | | |
| (Reserve) $ | | | | | | | |

| | Incurred/Service Month | | | | | |
|---|---|---|---|---|---|---|
| Calendar Month | Dec-01 | Jan-02 | Feb-02 | Mar-02 | Apr-02 | May-02 |
| Number of | 8 | 9 | 10 | 11 | 12 | 13 |
| Month | | | | | | |
| # | 16,677 | 18,505 | 18,279 | 18,245 | 18,093 | 18,058 |
| Members | | | | | | |
| for | | | | | | |
| reserves | | | | | | |
| estimation | | | | | | |
| Average | 91.401 | 100.216 | 80.055 | 88.926 | 93.746 | 92.405 |
| Claim | | | | | | |
| Rate | | | | | | |
| Estimated | 1,524,290 | 1,854,493 | 1,463,319 | 1,622,463 | 1,696,143 | 1,668,646 |
| Incurred | | | | | | |
| Claims $ | | | | | | |
| Estimated | 61,714 | 121,952 | 175,520 | 298,229 | 567,629 | 1,238,990 |
| Incurred | | | | | | |
| but not | | | | | | |
| Reported | | | | | | |
| Claims | | | | | | |
| (Reserve) $ | | | | | | |

Iterative Method for Estimation of Reserves

The iterative method is a mathematical technique that iteratively completes each cell of the claim lag triangle using the previous cells as input. Thus, an iterative calculation is used to determine the value of each cell. For the purposes of illustrating the iterative method for estimation reserves, a claim lag triangle having unique values is shown below in Table 19. The claim lag triangle shown in Table 19 includes values for 12 months of paid claims, and an employee paid amount of medical dollars.

TABLE 19
Claim Lag Triangle

| Calendar | Incurred Month | | | | | | |
|---|---|---|---|---|---|---|---|
| Month | Jun-01 | Jul-01 | Aug-01 | Sep-01 | Oct-01 | Nov-01 | Dec-01 |
| Jun-01 | 452,494 | | | | | | |
| Jul-01 | 681,641 | 405,550 | | | | | |
| Aug-01 | 204,624 | 660,011 | 437,787 | | | | |
| Sep-01 | 200,106 | 231,426 | 690,135 | 417,387 | | | |
| Oct-01 | 17,748 | 107,810 | 367,778 | 617,342 | 474,083 | | |
| Nov-01 | 17,997 | 65,640 | 53,168 | 256,459 | 682,192 | 407,673 | |
| Dec-01 | 5,258 | 22,049 | 74,421 | 85,579 | 196,974 | 625,153 | 442,587 |
| Jan-02 | 3,105 | 17,653 | 31,236 | 66,469 | 102,279 | 419,248 | 675,124 |
| Feb-02 | 3,103 | 5,212 | 14,744 | 5,988 | 65,293 | 71,569 | 231,065 |
| Mar-02 | 1,852 | 8,725 | 7,762 | 15,750 | 210,728 | 33,996 | 96,288 |
| Apr-02 | 3,969 | 3,390 | 4,699 | 4,317 | 15,866 | 25,843 | 10,388 |
| May-02 | 2,635 | −618 | 1,567 | 5,880 | 7,862 | 3,088 | 7,124 |
| Employer | 1,594,532 | 1,526,848 | 1,683,297 | 1,475,171 | 1,755,277 | 1,586,570 | 1,462,576 |
| Paid | | | | | | | |
| Amount | | | | | | | |
| Medical $ | | | | | | | |

| Calendar | Incurred Month | | | | |
|---|---|---|---|---|---|
| Month | Jan-02 | Feb-02 | Mar-02 | Apr-02 | May-02 |
| Jun-01 | | | | | |
| Jul-01 | | | | | |
| Aug-01 | | | | | |
| Sep-01 | | | | | |
| Oct-01 | | | | | |
| Nov-01 | | | | | |
| Dec-01 | | | | | |
| Jan-02 | 454,181 | | | | |
| Feb-02 | 608,263 | 380,028 | | | |
| Mar-02 | 383,807 | 674,512 | 423,140 | | |
| Apr-02 | 154,518 | 182,944 | 709,767 | 429,631 | |
| May-02 | 131,772 | 50,315 | 191,327 | 698,883 | 429,656 |
| Employer | 1,732,541 | 1,287,799 | 1,324,234 | 1,128,514 | 429,656 |
| Paid | | | | | |
| Amount | | | | | |
| Medical $ | | | | | |

As with the claims lag report method described above, the claim lag triangle shown in Table 19 is rearranged in Table 20 according to paid month.

TABLE 20
Rearranged Claims Lag Triangle

| Calendar | Incurred/Service Month | | | | | | |
|---|---|---|---|---|---|---|---|
| Month | Jun-01 | Jul-01 | Aug-01 | Sep-01 | Oct-01 | Nov-01 | Dec-01 |
| 0 | 452,494 | 405,550 | 437,787 | 417,387 | 474,083 | 407,673 | 442,587 |
| 1 | 681,641 | 660,011 | 690,135 | 617,342 | 682,192 | 625,153 | 675,124 |
| 2 | 204,624 | 231,426 | 367,778 | 256,459 | 196,974 | 419,248 | 231,065 |
| 3 | 200,106 | 107,810 | 53,168 | 85,579 | 102,279 | 71,569 | 96,288 |
| 4 | 17,748 | 65,640 | 74,421 | 66,469 | 65,293 | 33,996 | 10,388 |
| 5 | 17,997 | 22,049 | 31,236 | 5,988 | 210,728 | 25,843 | 7,124 |
| 6 | 5,258 | 17,653 | 14,744 | 15,750 | 15,866 | 3,088 | |
| 7 | 3,105 | 5,212 | 7,762 | 4,317 | 7,862 | | |
| 8 | 3,103 | 8,725 | 4,699 | 5,880 | | | |
| 9 | 1,852 | 3,390 | 1,567 | | | | |
| 10 | 3,969 | −618 | | | | | |
| 11 | 2,635 | | | | | | |

| Calendar | Incurred/Service Month | | | | |
|---|---|---|---|---|---|
| Month | Jan-02 | Feb-02 | Mar-02 | Apr-02 | May-02 |
| 0 | 454,181 | 380,028 | 423,140 | 429,631 | 429,656 |
| 1 | 608,263 | 674,512 | 709,767 | 698,883 | |
| 2 | 383,807 | 182,944 | 191,327 | | |
| 3 | 154,518 | 50,315 | | | |
| 4 | 131,772 | | | | |
| 5 | | | | | |
| 6 | | | | | |
| 7 | | | | | |
| 8 | | | | | |
| 9 | | | | | |
| 10 | | | | | |
| 11 | | | | | |

Table 21 shows the rearranged claims lag triangle values from Table 20, along with additional forecast data forecasting amounts of claims. These forecast claims data are forecast iteratively, as the values immediately below the claims triangle from Table 20 are calculated (i.e., those values shown in bold face in Table 21), and then these results (i.e., the highlighted values) are used to calculate the cells below them. For example, the bold cell corresponding to incurred/service month Jul-01 is calculated as the claim value corresponding to the prior incurred/service month multiplied by the sum of all the claims for all the prior calendar months for incurred/service month Jul-01 divided by the sum of all the claims for all the prior calendar months for incurred/service month Jun-01.

TABLE 21
Forecast of Claims

| Calendar | Incurred Month | | | | | | |
|---|---|---|---|---|---|---|---|
| Month | Jun-01 | Jul-01 | Aug-01 | Sep-01 | Oct-01 | Nov-01 | Dec-01 |
| 0 | 452,494 | 405,550 | 437,787 | 417,387 | 474,083 | 407,673 | 442,587 |
| 1 | 681,641 | 660,011 | 690,135 | 617,342 | 682,192 | 625,153 | 675,124 |
| 2 | 204,624 | 231,426 | 367,778 | 256,459 | 196,974 | 419,248 | 231,065 |
| 3 | 200,106 | 107,810 | 53,168 | 85,579 | 102,279 | 71,569 | 96,288 |
| 4 | 17,748 | 65,640 | 74,421 | 66,469 | 65,293 | 33,996 | 10,388 |
| 5 | 17,997 | 22,049 | 31,236 | 5,988 | 210,728 | 25,843 | 7,124 |
| 6 | 5,258 | 17,653 | 14,744 | 15,750 | 15,866 | 3,088 | 11157 |
| 7 | 3,105 | 5,212 | 7,762 | 4,317 | 7,862 | 5624 | 5224 |
| 8 | 3,103 | 8,725 | 4,699 | 5,880 | 6298 | 5713 | 5307 |
| 9 | 1,852 | 3,390 | 1,567 | 2096 | 2503 | 2271 | 2109 |
| 10 | 3,969 | −618 | 1811 | 1589 | 1897 | 1721 | 1599 |
| 11 | 2,635 | 2527 | 2789 | 2448 | 2923 | 2652 | 2463 |

| Calendar | Incurred Month | | | | |
|---|---|---|---|---|---|
| Month | Jan-02 | Feb-02 | Mar-02 | Apr-02 | May-02 |
| 0 | 454,181 | 380,028 | 423,140 | 429,631 | 429,656 |
| 1 | 608,263 | 674,512 | 709,767 | 698,883 | 665965 |
| 2 | 383,807 | 182,944 | 191,327 | 275503 | 267472 |
| 3 | 154,518 | 50,315 | 99544 | 105541 | 102465 |
| 4 | 131,772 | 50424 | 55749 | 59107 | 57385 |
| 5 | 52325 | 40416 | 44684 | 47376 | 45995 |
| 6 | 13615 | 10516 | 11627 | 12327 | 11968 |
| 7 | 6375 | 4924 | 5444 | 5772 | 5604 |
| 8 | 6476 | 5002 | 5530 | 5864 | 5693 |
| 9 | 2574 | 1988 | 2198 | 2330 | 2262 |
| 10 | 1951 | 1507 | 1666 | 1767 | 1715 |
| 11 | 3006 | 2322 | 2567 | 2721 | 2642 |

Table 22 below shows the estimation of reserves, which is calculated by totaling the values forecast beneath the claims lag triangle of Table 20.

TABLE 22
Estimation of Reserves

| Calendar | Incurred Month | | | | | | |
|---|---|---|---|---|---|---|---|
| Month | Jun-01 | Jul-01 | Aug-01 | Sep-01 | Oct-01 | Nov-01 | Dec-01 |
| 0 | 452,494 | 405,550 | 437,787 | 417,387 | 474,083 | 407,673 | 442,587 |
| 1 | 681,641 | 660,011 | 690,135 | 617,342 | 682,192 | 625,153 | 675,124 |
| 2 | 204,624 | 231,426 | 367,778 | 256,459 | 196,974 | 419,248 | 231,065 |
| 3 | 200,106 | 107,810 | 53,168 | 85,579 | 102,279 | 71,569 | 96,288 |
| 4 | 17,748 | 65,640 | 74,421 | 66,469 | 65,293 | 33,996 | 10,388 |
| 5 | 17,997 | 22,049 | 31,236 | 5,988 | 210,728 | 25,843 | 7,124 |
| 6 | 5,258 | 17,653 | 14,744 | 15,750 | 15,866 | 3,088 | 11157 |
| 7 | 3,105 | 5,212 | 7,762 | 4,317 | 7,862 | 5624 | 5224 |
| 8 | 3,103 | 8,725 | 4,699 | 5,880 | 6298 | 5713 | 5307 |
| 9 | 1,852 | 3,390 | 1,567 | 2096 | 2503 | 2271 | 2109 |
| 10 | 3,969 | −618 | 1811 | 1589 | 1897 | 1721 | 1599 |
| 11 | 2,635 | 2527 | 2789 | 2448 | 2923 | 2652 | 2463 |
| Estimate | 1,594,532 | 1,529,375 | 1,687,897 | 1,481,304 | 1,768,899 | 1,604,550 | 1,490,434 |
| Incurred | | | | | | | |
| Claims $ | | | | | | | |
| Estimate | 0 | 2,577 | 4,600 | 6,133 | 13,622 | 17,980 | 27,858 |
| Incurred | | | | | | | |
| but not | | | | | | | |
| Reported | | | | | | | |
| Claims | | | | | | | |

| Calendar | Incurred Month | | | | |
|---|---|---|---|---|---|
| Month | Jan-02 | Feb-02 | Mar-02 | Apr-02 | May-02 |
| 0 | 454,181 | 380,028 | 423,140 | 429,631 | 429,656 |
| 1 | 608,263 | 674,512 | 709,767 | 698,883 | 665965 |
| 2 | 383,807 | 182,944 | 191,327 | 275503 | 267472 |
| 3 | 154,518 | 50,315 | 99544 | 105541 | 102465 |
| 4 | 131,772 | 50424 | 55749 | 59107 | 57385 |
| 5 | 52325 | 40416 | 44684 | 47376 | 45995 |
| 6 | 13615 | 10516 | 11627 | 12327 | 11968 |
| 7 | 6375 | 4924 | 5444 | 5772 | 5604 |
| 8 | 6476 | 5002 | 5530 | 5864 | 5693 |
| 9 | 2574 | 1988 | 2198 | 2330 | 2262 |
| 10 | 1951 | 1507 | 1666 | 1767 | 1715 |
| 11 | 3006 | 2322 | 2567 | 2721 | 2642 |
| Estimate | 1,818,863 | 1,404,899 | 1,553,243 | 1,646,823 | 1,598,823 |
| Incurred | | | | | |
| Claims $ | | | | | |
| Estimate | 86,322 | 117,100 | 229,009 | 518,309 | 1,169,167 |
| Incurred | | | | | |
| but not | | | | | |
| Reported | | | | | |
| Claims | | | | | |

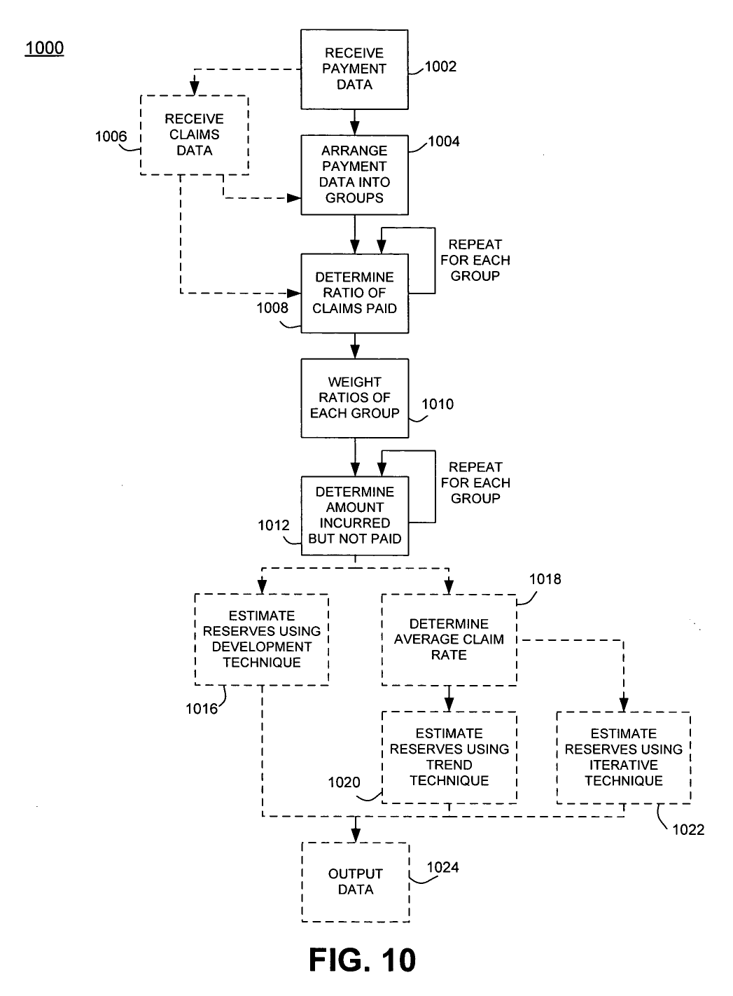

FIG. 10 is a flow diagram illustrating steps for forecasting future data, according to an embodiment of the invention. The technique 1000 shown in FIG. 10 illustrates reserve estimation using one or more of the forecasting techniques described above. The technique 1000 begins as payment data is received in step 1002. This payment data is arranged into groups in step 1004. Optionally, claims data can also be received in optional step 1006, and can likewise be arranged into groups in step 1004.

A ratio of claims paid is determined in step 1008, and this determination is repeated for each group into which payment data has been arranged. The ratios of each group are weighted in step 1010, and an amount incurred but not paid is determined in step 1012. This determination is then repeated for each group. The incurred but not reported claims, or reserves, can be estimated using one or more optional steps. Similarly, a claims lag report technique can be used in optional step 1016. An average claim rate can be determined in optional step 1018, and reserves can be estimated using a earned premium technique in optional step 1020, or using an iterative technique in optional step 1022. Once the reserves have been estimated, the data can be output in optional step 1024. As described above, this data can be output in a variety of formats convenient for one or more individuals or organizations associated with an entity that administers a benefit plan.

From the foregoing, it can be seen that one or more systems and methods for managing and monitoring financial performance associated with benefits are discussed. Specific examples of dashboards used to present integrated information to individuals associated with an entity that administers a benefit plan, and financial management techniques configured to estimate reserves and forecast other data have been described above. It will be appreciated, however, that embodiments of the invention can be in other specific forms without departing from the spirit or essential characteristics thereof. For example, the system and method of the invention can be used to prevent any common errors associated with benefit plans, such as overbilling, overpaying, and reporting errors. For example, using one or more embodiments of the invention, duplicate claims can be avoided, and accounting techniques can be verified. For example, payment processes can be controlled, risk associated with potential for lost assets can be mitigated, and compliance with pre-identified objectives can be certified. In other words, according to various embodiments of the invention, information can be tracked, and targeted data can be reported, where desired, future trends can be forecast, and historical trends can be tracked. For example, by matching one or more types of data described above, or other similar data, entities administrating a benefit plan can greatly improve accuracy, and prevent any unnecessary losses or inefficiencies associated with a benefit plan.

It will be recognized that many components and/or steps of the invention can be implemented interchangeably in software or hardware, or using a suitable combination of both. Additionally, the order of operations or steps of a process can be interchanged within the context of the invention. The presently disclosed embodiments are, therefore, considered in all respects to be illustrative and not restrictive.

What is claimed is:

1. A processor-readable medium comprising code representing instructions to cause a processor to:
receive first electronic data representing information associated with a plurality of claims under a benefit plan during a predetermined time period;
receive second electronic data representing information associated with a plurality of individuals enrolled within the benefit plan;
compare the first electronic data with the second electronic data; and
determine, for each claim from the plurality of claims, based on the comparison of the first electronic data with the second electronic data, if each claim is associated with an individual from the plurality of individuals enrolled within the benefit plan during the predetermined time period.

2. The processor-readable medium of claim 1, wherein the benefit plan is a first benefit plan, the code representing instructions being further configured to cause a processor to:
receive electronic data representing information associated with a plurality of claims under a second benefit plan during a pre-specified time period, the second benefit plan being different from the first benefit plan;
receive electronic data representing information associated with a plurality of individuals enrolled within the second benefit plan;
compare the electronic data representing information associated with a plurality of claims under the second benefit plan with the electronic data representing information associated with a plurality of individuals enrolled within the second benefit plan; and
determine, for each claim from the plurality of claims under the second benefit plan, based on the comparison, if each claim under the second benefit plan is associated with an individual from the plurality of individuals enrolled within the second benefit plan during the pre-specified time period.

3. The processor-readable medium of claim 1, further comprising code representing instructions to cause a processor to:
receive third electronic data representing information associated with a plurality of payments from a general ledger, the general ledger being associated with an entity administering the benefit plan, the processor-readable medium further comprising code representing instructions to cause a processor to compare the first electronic data with the third electronic data, the processor-readable medium further comprising code representing instructions to cause a processor to determine if each claim from the plurality of claims has a corresponding payment from the plurality of payments from the general ledger.

4. The processor-readable medium of claim 1, wherein the code representing instructions to cause a processor to compare is configured to cause the processor to compare in substantially real-time, the code representing instructions to determine being configured to cause the processor to determine in substantially real-time.

5. The processor-readable medium of claim 1, further comprising code representing instructions to cause a processor to:
receive third electronic data representing information associated with a plurality of payments from a general ledger, the general ledger being associated with an entity administering the benefit plan, the processor-readable medium further comprising code representing instructions to cause a processor to compare the first electronic data with the third electronic data, the processor-readable medium further comprising code representing instructions to cause a processor to determine if each claim from the plurality of claims has a corresponding payment from the plurality of payments from the general ledger.
identify, based on the comparison of the first electronic data with the third electronic data, any payment from the plurality of payments from the general ledger that does not have a corresponding claim from the plurality of claims.

6. The processor-readable medium of claim 1, further comprising code representing instructions to cause a processor to:
identify, based on the comparison of the first electronic data with the second electronic data, any claim from the plurality of claims that is not associated with an individual from the plurality of individuals enrolled within the benefit plan.

7. The processor-readable medium of claim 1, further comprising code representing instructions to cause a processor to:
determine, based on a comparison of the first electronic data with the second electronic data, for each claim from the plurality of claims, if any service from a plurality of services associated with a claim from the plurality of claims has been previously paid.

8. The processor-readable medium of claim 1, further comprising code representing instructions to cause a processor to:
determine, based on a comparison of the first electronic data with the second electronic data, for each claim from the plurality of claims, if any service from a plurality of services associated with a claim from the plurality of claims has been previously paid; and
identify any service from the plurality of services associated with any claim from the plurality of claims that has been previously paid.

9. A processor-readable medium comprising code representing instructions to cause a processor to:
receive electronic data associated with a plurality of payments of a plurality of claims under a benefit plan;
receive electronic data associated with an entity administering the benefit plan;
output information associated with the electronic data associated with the plurality of payments in a manner that shows the relationship of the plurality of payments to accounts associated with the entity administering the benefit plan during a pre-determined period.

10. The processor-readable medium of claim 9, wherein the pre-determined period includes the prior twelve months.

11. The processor-readable medium of claim 9, wherein the pre-determined period includes twelve successive one-month periods, each successive one-month period representing one of the prior twelve months.

12. The processor-readable medium of claim 9, wherein the code representing instructions to cause a processor to output information is configured to output the information organized according to accounts of the entity administering the benefit plan.

13. The processor-readable medium of claim 9, wherein the code representing instructions to cause a processor to output information is configured to output the information organized according to organization levels of the entity administering the benefit plan.

14. The processor-readable medium of claim 9, wherein the code representing instructions to cause a processor to output information is configured to output the information organized according to accounts of the entity administering the benefit plan, the code representing instructions to cause a processor to output information being configured to output the information organized according to organization levels of the entity administering the benefit plan.

15. The processor-readable medium of claim 9, wherein the code representing instructions to cause a processor to output information is further configured to output information representing actual claims amounts.

16. The processor-readable medium of claim 9, wherein the code representing instructions to cause a processor to output information is further configured to output information representing forecast claims amounts.

17. A processor-readable medium comprising code representing instructions to cause a processor to:
receive electronic data associated with a plurality of payments, each payment from the plurality of payments uniquely corresponding to a claim from a plurality of claims under a benefit plan;
arrange the plurality of payments into a plurality of groups of payments, each group of payments from the plurality of groups of payments being uniquely associated with a combination of an incurred month and a paid month, each payment from the plurality of payments being assigned to a group of payments from the plurality of groups of payments based on the claim uniquely corresponding to that payment having been incurred during the uniquely associated incurred month, each payment from the plurality of payments being assigned to a group from the plurality of groups of payments further based on the payment having been paid during the uniquely associated paid month; and
determine, for each group of payments from the plurality of groups of payments, a ratio of claims paid through the paid month uniquely associated with that group.

18. The processor-readable medium of claim 17, wherein the code representing instructions to cause a processor to determine is configured to calculate the ratio for a first group by dividing the amount of payments in the first group by the amount of payments in a second group having the same incurred month as the first group, the second group having a paid month that is one month later than the paid month of the first group.

19. The processor-readable medium of claim 17, further comprising code representing instructions to cause a processor to:
weight the ratio of claims paid for each group of payments from the plurality of groups of payments relative to one another.

20. The processor-readable medium of claim 17, further comprising code representing instructions to cause a processor to:
determine, for each group of payments from the plurality of groups of payments, an amount associated with claims incurred within the incurred month uniquely associated with that group of payments but not associated with any payment.

21. The processor-readable medium of claim 17, further comprising code representing instructions to cause a processor to:
estimate, for each group of payments from the plurality of groups of payments, a number of payments incurred but not reported using a completion factor technique.

22. The processor-readable medium of claim 17, further comprising code representing instructions to cause a processor to:
determine an average claim rate associated with each group of payments from the plurality of groups of payments; and
estimate, for each group of payments from the plurality of groups of payments, a number of payments incurred but not reported using an average claims rate technique.

23. The processor-readable medium of claim 17, further comprising code representing instructions to cause a processor to:
group the ratios of paid payments to incurred payments based on the time period between when the payment was incurred and when the payment was paid;
determine an average claim rate associated with each group of ratios; and
estimate, for each group of payments from the plurality of groups of payments, a number of payments incurred but not reported using an average claims rate technique.

24. The processor-readable medium of claim 17, further comprising code representing instructions to cause a processor to:
determine an average claim rate associated with each group of payments from the plurality of groups of payments; and
estimate, for each group of payments from the plurality of groups of payments, a number of payments incurred but not reported using an iterative technique.
